(19) United States
(12) Patent Application Publication
(10) Pub. No.: US 2023/0302409 A1
(43) Pub. Date: Sep. 28, 2023

(54) Filtration Device For Bioprocessing

(71) Applicant: EMD Millipore Corporation, Burlington, MA (US)

(72) Inventors: Heejin Lee, Bedford, MA (US); Michael James Susienka, Boylston, MA (US); Johnathan Lawson, Chelmsford, MA (US); John Paul Amara, Reading, MA (US); Joseph Michael Almasian, Westford, MA (US); Sean Foley, Marlborough, MA (US); James Ormond, Belmont, MA (US)

(21) Appl. No.: 18/034,243

(22) PCT Filed: Nov. 16, 2021
(86) PCT No.: PCT/US2021/059460

§ 371 Date: Apr. 27, 2023

Related U.S. Application Data
(60) Provisional application No. 63/114,623, filed on Nov. 17, 2020.

(51) Int. Cl. B01D 61/18; B01D 63/08

(52) U.S. Cl. CPC B01D 61/18; B01D 63/082; B01D 2313/54; B01D 2313/13; B01D 2313/105; B01D 2313/125; B01D 2313/16; B01D 2313/06; B01D 2313/041

(57) ABSTRACT

An apparatus for treating a biological fluid, comprising a plurality of filtration devices. In some embodiments, each of the plurality of filtration devices comprising at least one inlet and at least one outlet; and a first insert plate and a second insert plate opposite the first insert plate, wherein the plurality of filtration devices is disposed therebetween. In some embodiments, each filtration device has a vent port. A manifold for each of the inlets, outlets, and vent ports is optionally fluidly connected. In another embodiment, hose barb connectors or the like may be protected from damage and/or exposure by being recessed in the device or positioned at a periphery of the device. Embodiments include apparatus and methods to achieve dripless connect/disconnect and to reduce the number of sterile-to-sterile connections.

This application claims priority of U.S. Provisional Application Ser. No. 63/114,623 filed Nov. 17, 2020, the disclosure of which is hereby incorporated by reference in its entirety.

### BACKGROUND

### Field of the Disclosure

Embodiments of the present disclosure relate to the processing of biological fluids. More particularly, embodiments disclosed herein are related to filtration devices for bioprocessing. In some embodiments, a filtration device can comprise, for example, a device having a depth filter, a viral clearance filter, a TFF filter, a membrane including a membrane adsorber or chromatography membrane, a chromatography resin, or other filters as known to those in the art.

### Description of the Related Art

Traditionally, depth filter devices are single-use, modular depth filtration devices used for primary and secondary clarification of biopharmaceutical feed streams. To enable the pilot and process scale clarification of unclarified cell cultures used in large scale manufacturing of recombinant biological therapeutics, such as monoclonal antibodies (mAbs) (e.g. 200 L-3,000 L), multiple devices are stacked and loaded in a stainless-steel filter holder. The assembly of stacked devices are compressed (for e.g., 1,000 psi) using a hydraulic pump attached to the holder to create fluid-tight seals between multiple adjacent devices. The devices may reach internal pressures up to 50 PSI (pounds per square inch) during operation. Current device formats include disposable adapters and/or other connectors having ports, along with gaskets, fittings, and/or tubing, which are separately installed prior to initiation of a clarification operation. These current device formats are not suitable for closed processing operations because the connection ports are open to the ambient environment, which is a vector for a loss of sterility, even within sterile environments. These device formats present a risk of product cross-contamination and a risk of operator exposure to biological materials.

Bioprocessing operations where the process fluids containing the biological and biopharmaceutical products may be exposed to the environment within the manufacturing space must take precautions to ensure process cleanliness and to avoid contamination of the product. Such bioprocessing operations must therefore be executed in controlled, classified spaces (i.e. “clean rooms”) to minimize the risk of contamination of the product feed stream. Classified spaces are very expensive to construct, operate, and maintain. Despite the precautions undertaken to avoid contamination, contamination events can still occur. Contamination can result in shut-downs, cleaning and revalidation, each of which is expensive and time consuming. Accordingly, bioprocessing equipment and materials need to be sterilized prior to use in order to minimize contamination risk. In view of the expense and time commitment needed to construct, operate and maintain controlled environments, there is a desire of biopharmaceutical manufacturers to move bioprocessing operations into controlled, non-classified spaces (i.e., “gray spaces”) to allow for manufacturing flexibility as well as potential cost savings. While existing bioprocessing filters, especially depth filtration, tangential flow filtration, and virus filtration devices, may be sterilized prior to use, use of these devices in gray spaces would cause their sterility to be immediately breached upon removal from their bag or other packaging container due to the one or more open fluid ports present on the devices. These fluid ports are necessary to allow for modularity, i.e., the ability to vary the total filtration area, media grades, or other features depending on batch size, product attributes, etc., and thus their elimination is not a viable option.

Therefore, there exists a need for fully enclosed, sterile filtration devices having aseptic connections connectable to other bioprocessing operations.

A current industry trend in biopharmaceutical manufacturing is toward the development of multi-product production facilities. For efficient operation in such facilities, potential sources of product contamination should be reduced or eliminated using fully closed filtration devices. It is desirable that devices are connected/disconnected from the process fluids without exposing the production facility or its operators to the process fluid. Other recent industry trends include intensified batch mode and continuous bioprocessing. “Continuous mode” operations often occur over much longer periods of time (e.g., several days or weeks) compared to traditional “batch mode” operations, which typically occur over a few hours/within a single day. Continuous processing applications often employ perfusion bioreactors, which are designed to operate for several days or weeks in order to maintain high productivity of the cell culture. In batch processes, a cell culture is maintained for set periods of time, followed by harvesting the entire culture within a batch. In continuous harvest systems, e.g., perfusion processes, where spent cell culture medium is removed and replaced, the product-containing permeate is collected from the cell culture on a continuous basis over long durations, resulting in increased product titers and higher volumes of waste and dead cells, which are removed during downstream processes. Upstream and downstream processes are, therefore, subject to balancing the interests of processing times, product concentrations, and quality.

There are several methods and apparatus for retaining cells in the perfusion bioreactor, including TFF-based cell retention devices, marketed under the tradename Cellicon®, by EMD Millipore Corporation, alternating tangential flow XCell™ ATF, or tangential flow depth filtration TFDF™, both marketed by Repligen Corp. In some embodiments of these perfusion processes, the perfusate generated by these devices may require a secondary depth filtration step to further reduce turbidity and/or soluble impurities to render the feedstream suitable for subsequent sterilizing-grade filtration, i.e., through a 0.22 μm pore size membrane, and capture chromatography steps. Because the depth filters employed in these applications will likely require longer operation times (several days or weeks), the depth filters are sterilized (or bioburden-reduced) to minimize risk of upstream contamination of the bioreactor and also available in a fully-closed device format to allow for easier and more efficient changeout of the spent/used filters during operation (i.e., “hot-swapping”), as may be conducted in controlled non-classified (CNC) or “gray space”/ballroom production facilities. Furthermore, in other embodiments of continuous or semi-continuous processes, one or more secondary depth filtration step(s) may be required further downstream, e.g., after protein A capture chromatography and/or low pH viral inactivation steps. Depth filtration may also be employed as a prefiltration step prior to a virus filtration step. Similarly, closed and sterile depth filters are used in these downstream applications to minimize the risk of contamination over extended periods of operation.

At least one drawback of prior art attempts is that the sterility of the internal flow paths within depth filter installations that comprise multiple filters/filter devices is not maintained after sterilization (e.g., via gamma irradiation, X-ray, electron beam (e-beam), ethylene oxide, or autoclaving) of the filter device. The connection ports (e.g., inlet, outlet, and vent) of the filter devices are directly exposed to the ambient environment upon unpacking, while loading them into a holder, and, also, while connecting multiple pods/filter devices together and/or their associated adapters/connectors and/or tubing.

It is therefore an advance in the art to provide a system and methods for overcoming the drawbacks associated with current depth filtration devices to permit closed processing operations. Also, it is an advance in the art to provide a system that eliminates or significantly reduces product cross-contamination and risks to manual operators, who may be exposed to biological materials. It is a further advance to provide pre-sterilized or bioburden-reduced depth filter devices that can be used within these closed processing facilities. It is a further advance to provide apparatus and methods that enable the aseptic installation of these devices, preserving the sterility of the devices and reducing the need for expensive cleanroom facilities during bioprocessing. In some embodiments, certain features provide for the dripless removal of these devices, wherein the operator safety is ensured, the cleanliness of the manufacturing environment is preserved and facilitate the changeout of filter devices for continuous manufacturing processes in an efficient manner.

### SUMMARY

An apparatus for treating a biological fluid, comprising a plurality of pods; each of the plurality of pods comprising at least one inlet, at least one outlet, and in some at least one vent port; and a first insert plate and a second insert plate opposite the first insert plate, wherein the plurality of pods is disposed therebetween. A manifold for each of inlets, outlets, and vent ports is optionally connected; substantially as shown in and/or described in connection with at least one of the figures, as set forth more completely in the claims.

In another embodiment, an apparatus for the chromatographic purification of a biological fluid using a membrane adsorber device, comprising a plurality of membrane adsorber devices; each of the plurality of devices comprising at least one inlet and at least one outlet; and a first insert plate and a second insert plate opposite the first insert plate, wherein the plurality of membrane adsorber devices is disposed therebetween. A manifold for each of inlets and outlets is optionally connected. In this embodiment, the apparatus is devoid of a vent port.

Embodiments disclosed herein relate to a device that enables closed bioprocessing, such as so-called “downstream processing”, e.g., processing (e.g., depth filtration) to remove or reduce contaminants from material that has been harvested in a bioreactor. In certain embodiments, the device enables aseptic fluid transfer. In some embodiments, the device is pre-sterilized and is a disposable device adapted for single-use. In certain embodiments, the device is a pre-assembled series of individual filtration packets, each of which contains filtration media and/or one or more membranes. In certain embodiments, the pre-assembled series of packets are under tension, such as with tie rods loaded to a particular force, e.g. 300 lbf each. The packets and endcaps may be interconnected to form modules, and one or more modules together with manifold endcaps may be held together to form a modular assembly and prevent unwanted ingress through one or more fluid ports. The complete assembled device may be sterilized, such as for example by gamma radiation, X-ray, autoclaving, steaming, ozone or ethylene oxide treatment, to render the interior of the device sterile. Aseptic connections may be made to process tubing, thereby permitting aseptic fluid transfer such as filtration operations without contaminating either the filtration media or the process fluid.

In some embodiments, disclosed is a modular filtration device for use in fully closed or functionally closed processing applications that reduces risk of product contamination and maintains product integrity. In some embodiments, the modular filtration device includes one or more filtration devices, particularly flat-plate filtration cassette devices such as those commercially available under the Millistak+® HC, Millistak+® HC Pro and Clarisolve® names (or Pod depth filter devices or pods), that may be pre-sterilized and may contain suitable media for primary and secondary clarification of biopharmaceutical feed streams, or for viral filtration, for example. Multiple filtration devices or pods may be stacked in parallel and loaded in a suitable holder. Stacks can be horizontal or vertical or both. In certain embodiments, in order to achieve a closed processing operation, where the filtration device is closed from the environment during the entire use cycle of the device, aseptic connection points (e.g., inlet, outlet and vent ports) and internal passageways are provided and maintained in a sterile and closed environment to protect them from contamination, enabling aseptic connection and disconnection of the filtration device from process fluids without exposing the production facility or the operators to the process fluid. Embodiments disclosed herein provide alternative ways of achieving this.

For example, in some embodiments one or more insert plates may be assembled to a pod, the insert plates each having one or more ports and/or slots that align with hose barb connection components or the like extending from the pod and that receive the hose barb connection components within the thickness of the plates (e.g., so that the connection components are fully or partially recessed) to contain and protect the components (which may include tubing) from exposure to the environment. The insert plates enable neat arrangement of tubing and manifolds, and may be reusable. In other embodiments, insert plates are not used, but the hose barb connection components or the like extend from a peripheral side of a pod rather than from a front face of the pod, or are recessed in the body of the pod itself so that they do not extend out of the pod body.

In some embodiments, multiple pods may be pre-combined and loaded onto a cart for easy transportation, and/or encapsulated or enclosed by a sterile barrier. The sterile barrier may include one or more rigid or hard bases, and a polymer/plastic film welded thereto. The rigid or hard bases are sufficiently hard so as to be capable of supporting the polymer/plastic film welded thereto, including bases made from LDPE, HDPE, ABS and/or nylon. Sterile-to-sterile connectors may be used to connect to hose barb fittings or the like, either before or after the pod assembly is enclosed and sterilized. In another embodiment, the pod assembly is enclosed in a poly bag, the pods may be compressed to create fluid-tight seals between adjacent pods, and then the poly bag may be opened to expose pre-assembled sterile-to-sterile connectors. One or more manifolds may be used to connect multiple pods. Sterile pod-to-pod connections can be made between depth filter devices using connector plates having Lynx® S2S style female couplings, for example.

Accordingly, in some embodiments, disclosed is apparatus for treating a biological fluid, comprising a plurality of filtration devices; each of the plurality of filtration devices comprising filtration media, at least one inlet and at least one outlet; and a first insert plate and a second insert plate opposite the first insert plate, wherein the plurality of filtration devices is disposed therebetween. Each of said plurality of filtration devices may further comprise at least one vent port. The at least one inlet may further comprise a sterile-to-sterile connector. The at least one outlet may further comprise a sterile-to-sterile connector. The at least one vent port may terminate at a vent filter. The at least one inlet from each of the plurality of device may be connected to be in fluid communication with each other via a manifold. The at least one outlet from each of the plurality of devices may connected to be in fluid communication with each other via a manifold. The at least one vent port from each of the plurality of devices may be connected to each other to be in fluid communication via a manifold. Any or all of the manifolds may comprise a sterile-to-sterile connector.

The filtration media may comprise media effective for virus filtration, depth filtration or adsorptive filtration. The filtration media may comprise a chromatography membrane.

The plurality of filtration devices may. be combined and loaded onto a cart having holder hardware comprising a side A and a side B. The apparatus holder hardware may comprise one or more of a pressure gauge, a hydraulic pump, a clamp rod, a frame, and two platens.

In some embodiments, disclosed is apparatus for sealing a sterilized filtration device, comprising: a container comprising two hard bases and a plastic film, having a plurality of filtration devices disposed therebetween, wherein one of the hard bases has a protruded hose barb fitting connected to tubing and a sterile-to-sterile connector, the plastic film sealing the plurality of filtration devices between the hard bases. The plastic film may be thermally welded, bonded or otherwise joined to at least part of a perimeter of the hard bases. There may be two plastic films, wherein the plastic film overhangs the perimeter of the hard bases. At least one of the hard bases may include an alignment key. Each end plate may have at least one groove for holding a strapping band. There may be at least one hose barb adapter or at least one blind end cap, wherein each hose barb adapter or blind end cap adaptor further comprises a gasket and a snap fit connection.

In some embodiments an assembly comprises a filtration module comprising filtration media and one or more fluid ports; and an insert plate having a thickness and configured to attach to a face of said filtration module, the insert plate having at least one recess configured and positioned to receive a connecting component that is fluidly connectable to one of said fluid ports such that said connecting component is contained within the thickness of said insert plate when said insert plate is attached to the face of said filtration module. The filtration module may be enclosed in a sterile barrier, which may include a poly bag.

In some embodiments an assembly comprises a filtration module comprising filtration media and one or more fluid ports; the filtration module having an end face, the end face having at least one recess configured and positioned to receive a connecting component that is fluidly connectable to one of the fluid ports such that the connecting component is contained within the recess. filtration module may be enclosed in a sterile barrier, which may include a poly bag.

In some embodiments, disclosed is a method of deploying a seal into a filtration device comprising filtration media, an inlet and an outlet, the method comprising inserting an applicator into each of the inlet and outlet, and introducing through each applicator a sealing material. The sealing material may comprise cotton, rayon, foam, polyurethane, polyether, polyester or cellulose.

In some embodiments, disclosed is apparatus for treating a biological fluid, comprising: a plurality of filtration devices; each of the plurality of filtration devices comprising filtration media, at least one inlet and at least one outlet; wherein inlets of two of the plurality of filtration devices are fluidly connected by a first Y-connector. The outlets of two of the plurality of filtration devices may be fluidly connected by a second Y-connector. Each of the plurality of filtration devices may further comprise a vent, and vents of two of the plurality of filtration devices may be fluidly connected by a third Y-connector. Any or all of the Y-connectors may be fluidly connectable or connected to a manifold.

Various benefits, aspects, novel and inventive features of the present disclosure, as well as details of exemplary embodiments thereof, will be more fully understood from the following description and drawings.

### BRIEF DESCRIPTION OF THE DRAWINGS

FIGS. 1A-1F depict various views of a modular depth filter device, comprising an insert plate, connectors, and a process scale pod (PSP), according to embodiments of the disclosure;

FIGS. 2A-2E depict perspective and other views of a plurality of modular depth filter devices, comprising an insert plate, connectors, and a manifold(s), according to embodiments of the disclosure;

FIGS. 3A-3C depict views of a plurality of modular depth filter devices, comprising an alternative insert plate and alternative connectors, according to embodiments of the disclosure;

FIGS. 4A-4E depict perspective views of a modular depth filter device, comprising a second alternative insert plate, connectors, and blind end components, according to embodiments of the disclosure;

FIGS. 5A and 5B each shows at least one embodiment of a pod with an end plate, three hose barb connectors in fluid communication via tubing with an inlet, a vent, and an outlet, according to embodiments of the disclosure;

FIGS. 6A-6E depict two embodiments of ends plates according to some embodiments of the disclosure;

FIGS. 7A-C depict some embodiments of three PSPs joined using manifold assemblies, according to embodiments of the disclosure;

FIG. 8A and 8B depict an assembly of at least one approach for joining a plurality of filter devices, according to some embodiments of the disclosure;

FIGS. 9A and 9B depict multi-rack of process scale pods, according to some embodiments of the disclosure;

FIG. 10 depicts at least one embodiment of a container comprising two hard bases and a plastic film, according to some embodiments of the disclosure;

FIG. 11 depicts a container having a plastic film thermally welded, bonded or otherwise joined to at least part of a perimeter of hard bases optionally comprising overhangs, according to some embodiments of the disclosure;

FIG. 12 depicts a plurality of PSPs enclosed in a container, according to some embodiments of the disclosure;

FIG. 13 depicts a plurality of PSPs enclosed in the container, disposed on a cart, according to some embodiments of the disclosure;

FIGS. 14A and 14B depict the hard bases of FIGS. 12-13, further comprising clamp rods, according to some embodiments of the disclosure;

FIGS. 15A and 15B respectively depict a simplified schematic view and a perspective view of the container, further comprising spacers between the pods, according to embodiments of the disclosure;

FIG. 16 depicts a container system, further comprising at least one hose barb and one blind end cap adaptor, according to some embodiments of the disclosure;

FIG. 17 depicts an exploded view of a plurality of PSPs, two support plates, a connector, and snap-fit adaptors, according to some embodiments of the disclosure;

FIG. 18 depicts an assembled container 1800 of the exploded view of FIG. 17, according to some embodiments of the disclosure, further comprising strapping;

FIGS. 19A-19C depicts front views of three embodiments of the pods in a poly bag, according to some embodiments of the disclosure;

FIG. 20 depicts a plurality of pods on a cart, wherein the respective inlet ports, outlet ports, and vent ports are in fluid communication, according to some embodiments of the disclosure;

FIGS. 21A-21D depict a plurality of pods in various states of installation within a holder device, according to some embodiments of the disclosure;

FIGS. 22A, 22B, 23A, 23B, 24A, 24B, 25A, 25B, 26A and 26B depict steps for making sterile connections between filter devices or pods, according to some embodiments of the disclosure;

FIG. 27 depicts a fluid transfer device comprising a connector for making connections between pods, according to some embodiments of the disclosure;

FIG. 28 is a perspective view of a pod with modified endcaps having eyelets for receiving tie rod, according to some embodiments of the disclosure;

FIG. 29A is a perspective exploded view of a T-port, and FIG. 29B is a cross-sectional view of a T-port in a pod, according to some embodiments of the disclosure;

FIG. 30 is a perspective view, in cross-section, of a T-port with a double applicator for deploying plugs/seals, according to some embodiments of the disclosure;

FIG. 31 shows embodiments of integrated valving, according to some embodiments of the disclosure;

FIG. 32 is a schematic view of an integrated check valve according to some embodiments of the disclosure;

FIG. 33 is a schematic view of a standard configuration for manifolding multiple pods;

FIG. 34 is a schematic view of multiple pods manifolded with a reduced number of sterile-to-sterile connectors, according to some embodiments of the disclosure;

FIG. 35 is another schematic view of multiple pods manifolded with a reduced number of sterile-to-sterile connectors, according to some embodiments of the disclosure;

FIGS. 36A and 36B are views of depth filtration devices with angled fittings, according to some embodiments of the disclosure;

FIGS. 37A and 37B are chromatography devices with angled fittings, according to some embodiments of the disclosure;

FIGS. 38A and 38B are views of depth filtration devices with a manifold having different branch lengths;

FIGS. 39A and 39B are perspective views of depth filtration devices concave and convex mating features to reduce thickness, according to some embodiments of the disclosure;

FIGS. 40A, 40B, 40C, 40D, 40E and 40F are perspective views of filtration devices with Y-connectors fluidly joining two inlets, two outlets and two vent ports of pairs of filtration devices to halve the number of sterile connections, according to some embodiments of the disclosure.

### DETAILED DESCRIPTION

So the manner in which the features disclosed herein can be understood in detail, a more particular description of the embodiments of the disclosure, briefly summarized above, may be had by reference to the appended drawings. It is to be noted, however, that the appended drawings illustrate only typical embodiments of this disclosure and are therefore not to be considered limiting of its scope, for the embodiments described and shown may admit to other equally effective embodiments. It is also to be understood that elements and features of one embodiment may be found in other embodiments without further recitation and that identical reference numerals are sometimes used to indicate comparable elements that are common to the figures.

The term “cell culture” refers to cells grown in suspension, roller bottles, flasks and the like, as well as the components of the suspension itself, including but not limited to cells, cell debris, cellular contaminants, colloidal particles, biomolecules, host cell proteins (HCP) and DNA, mAbs, antibody-drug conjugates (ADCs), viral vectors, and/or flocculants. Large scale approaches, such as bioreactors, including adherent cells growing attached to microcarriers in stirred fermenters, are also within the meaning of the term “cell culture.”

The terms “cell culture medium/media” and “culture medium/media” refer to a nutrient solution used for growing animal cells, e.g., mammalian cells. Such a nutrient solution generally includes various factors necessary for cell attachment, growth, and maintenance of the cellular environment. For example, a typical nutrient solution may include a basal media formulation, various supplements depending on the cell type and, occasionally, antibiotics. In some embodiments, a nutrient solution may include at least one component from one or more of the following categories: 1) an energy source, usually in the form of a carbohydrate such as glucose; 2) one or more essential amino acids and/or cysteine; 3) vitamins and/or other organic compounds; 4) free fatty acids; and 5) trace elements, where trace elements are defined as inorganic compounds.

The terms “filter device(s),” “pod(s),” “Pod,” “process scale pod” and the acronym “PSP” are used interchangeably in this disclosure and are meant to indicate any filter module.

The term “depth filter” is a filter that achieves filtration within the depth of the filter material. Particle separation in depth filters results from entrapment by or adsorption to, the fiber and filter aid matrix comprising the filter material.

The terms “bioreactor,” “bag,” and “container” are generally used interchangeably within this disclosure. The term bioreactor, bag, and container as used herein refers to any manufactured or engineered device or system that supports a biologically active environment. In some instances, a bioreactor is a vessel having an inner volume in which a cell culture process is carried out which involves organisms or biochemically active substances derived from such organisms. A flexible bioreactor, bag, or container connotes a flexible vessel that can be folded, collapsed, and expanded and/or the like, capable of containing, for example, a biological fluid. A single use bioreactor, bag, or container, typically also flexible, is a vessel that is used once and discarded.

The terms “sterile” and “sterilized” are defined as a condition of being free from contaminants and, particularly within the bioprocessing industry, free from pathogens, such as undesirable viruses, bacteria, germs, and other microorganisms. Relatedly, the terms “bioburden-reduced” and “bioburden reduction” (e.g., by a non-sterilizing dose of gamma or X-ray radiation<25 kGy) may be substituted for certain embodiments that do not necessitate a sterile claim.

The term “upstream” is defined as first step processes in the processing of biological materials, such as microbes/cells, mAbs, ADCs, proteins, including therapeutic proteins, viral vectors, etc., are grown or inoculated in bioreactors within cell culture media, under controlled conditions, to manufacture certain types of biological products.

The term “downstream” indicates those processes in which biological products are harvested, tested, purified, concentrated and packaged following growth and proliferation within a bioreactor.

The term “monoclonal antibody” (mAbs) as used herein refers to an antibody obtained from a population of substantially homogeneous antibodies, i.e., the individual antibodies comprising the population are identical except for possible naturally occurring mutations that may be present in minor amounts. Monoclonal antibodies may further include “chimeric” antibodies (immunoglobulins) in which a portion of the heavy and/or light chain is identical with or homologous to corresponding sequences in antibodies derived from a particular species or belonging to a particular antibody class or subclass.

The term “continuous process” refers to a process for purifying a target molecule, which includes two or more process steps (or unit operations), such that the output from one process step flows directly into the next process step in the process, without interruption, and where two or more process steps can be performed concurrently for at least a portion of their duration. In other words, in case of a continuous process, as described herein, it is not necessary to complete a process step before the next process step is started, but a portion of the sample is always moving through the process steps.

The term “semi-continuous process” refers to a generally continuous process for purifying a target molecule, where input of the fluid material in any single process step or the output is discontinuous or intermittent. In some embodiments, the processes and systems described herein are “semi-continuous” in nature, in that they include a unit operation which is operated in an intermittent matter, whereas the other unit operations in the process or system may be operated in a continuous manner.

The term “clarification” is defined as a downstream process, wherein whole cells, cellular debris, soluble impurities (HCP and/or DNA), suspended particles, and/or turbidity are reduced and/or removed from a cell culture feedstream using centrifugation and/or depth filtration. The terms “clarify,” “clarification,” “clarification step,” and “harvest” generally refer to one or more steps used initially in the purification of biomolecules. The clarification step generally comprises the removal of whole cells and/or cellular debris during a harvest operation from a bioreactor but may also comprise turbidity reduction for downstream process intermediates or pre-filters to protect other sensitive filtration steps, e.g. virus filtration.

The term “purification” is defined as a downstream process, wherein bulk contaminants and impurities, including host cell proteins, DNA and process residuals are removed from the product stream.

The term “polishing” is defined as a downstream process, wherein trace contaminants or impurities that resemble the product closely in physical and chemical properties are eliminated from the purified product stream.

The term “chromatography” is defined as a downstream separations process suitable for biological chromatographic techniques, comprising, but not limited to, protein A chromatography, affinity chromatography, hydrophobic interaction chromatography, capture chromatography, column chromatography, and ion exchange chromatography, e.g., anion exchange chromatography, and cation exchange chromatography. “Chromatography” also refers to any kind of technique which separates an analyte of interest (e.g., a target molecule to be concentrated as a product) from other molecules present in a mixture. Usually, the analyte of interest is separated from other molecules as a result of differences in rates at which the individual molecules of the mixture migrate through a stationary medium.

The term “affinity chromatography matrix” refers to a chromatography matrix which carries ligands suitable for affinity chromatography. Typically, the ligand (e.g., Protein A or a functional variant or fragment thereof) is covalently attached to a chromatography matrix material and is accessible to the target molecule in solution as the solution contacts the chromatography matrix. One example of an affinity chromatography matrix is a Protein A matrix. An affinity chromatography matrix typically binds the target molecules with high specificity based on a lock/key mechanism such as antigen/antibody or enzyme/receptor binding. The processes and systems described may comprise an affinity chromatography step that may be used as the bind and elute chromatography step in a purification process.

The terms “ion-exchange” and “ion-exchange chromatography” refer to the chromatographic process in which a solute or analyte of interest (e.g., a target molecule being purified) in a mixture, interacts with a charged compound linked (such as by covalent attachment) to a solid phase ion exchange material, such that the solute or analyte of interest interacts non-specifically with the charged compound more or less than solute impurities or contaminants in the mixture. The contaminating solutes in the mixture elute from a column of the ion exchange material faster or slower than the solute of interest or are bound to, or excluded from, the resin relative to the solute of interest.

“Ion-exchange chromatography” specifically includes cation exchange, anion exchange, and mixed mode ion exchange chromatography. Ion-exchange chromatography methods are generally charge-based separations. For example, cation exchange chromatography can bind the target molecule (e.g., an Fc region containing target protein) followed by elution (e.g., using cation exchange bind and elute chromatography or “CIEX”) or can predominately bind the impurities while the target molecule “flows through” the column (cation exchange flow through chromatography FT-CIEX). Anion exchange chromatography can bind the target molecule (e.g., an Fc region containing target protein) followed by elution or can predominately bind the impurities while the target molecule “flows through” the column, also referred to as negative chromatography. In some embodiments, anion exchange chromatography is performed in a flow through mode.

The term “impurity” or “contaminant” as used herein, refers to any foreign or disfavored molecule, including a biological macromolecule such as DNA, RNA, one or more host cell proteins, endotoxins, lipids, flocculation polymer, surfactant, antifoam additive(s), and one or more additives which may be present in a sample containing the target molecule that is being separated from one or more of the foreign or disfavored molecules using a process described herein. Additionally, such impurity may include any reagent which is used in a step which may occur prior to the method of the invention. Impurities may be soluble or insoluble.

The term “adjuvant” within this disclosure is defined as a substance that enhances a body's immune response to, for e.g., an antigen.

The term “(fully) closed system” as used herein is a process system that is designed and operated such that the product is never exposed to the surrounding environment.

The term “functionally closed system” is a process that may be routinely opened but is returned to a closed state through a sanitization or sterilization step prior to process use, such as process vessels that may be cleaned in place and steamed in place between uses.

The term “sterilization” is a bioburden-free (sterile) condition, created via, for example, thermal sterilization (121° C./15 minutes or higher); sterile filtration (0.2 μm pore size membranes or better), chemical sterilization (e.g., VHP, chlorine dioxide, ozone), or irradiation (gamma, X-ray, UV).

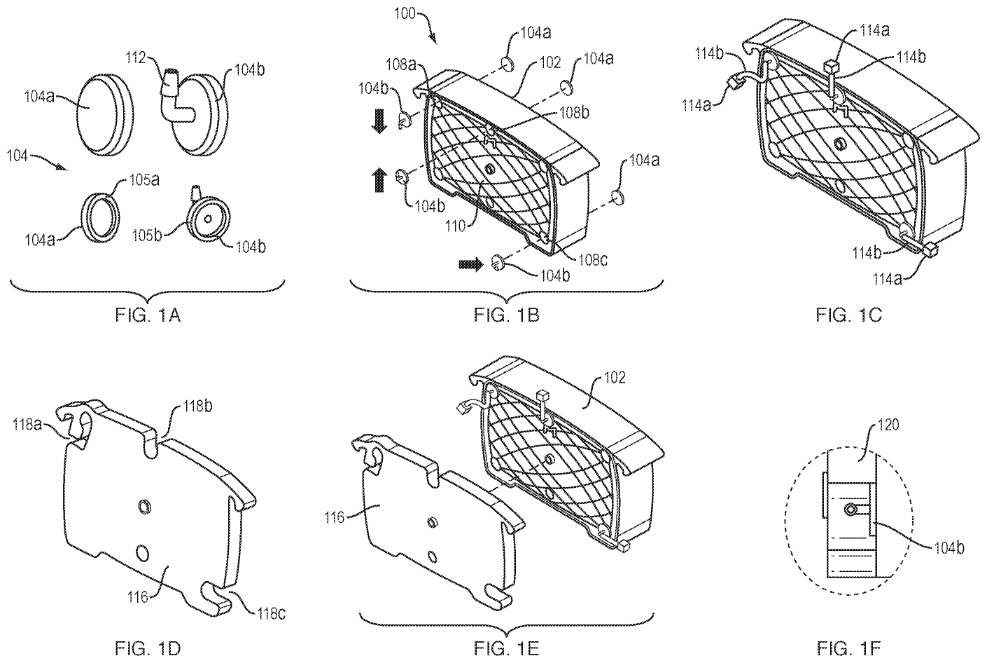

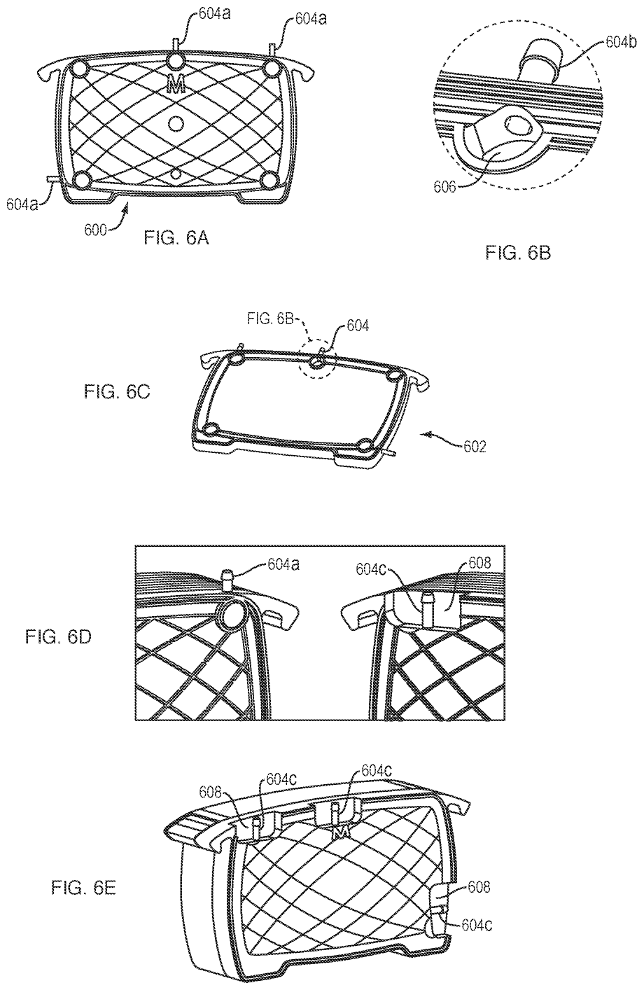

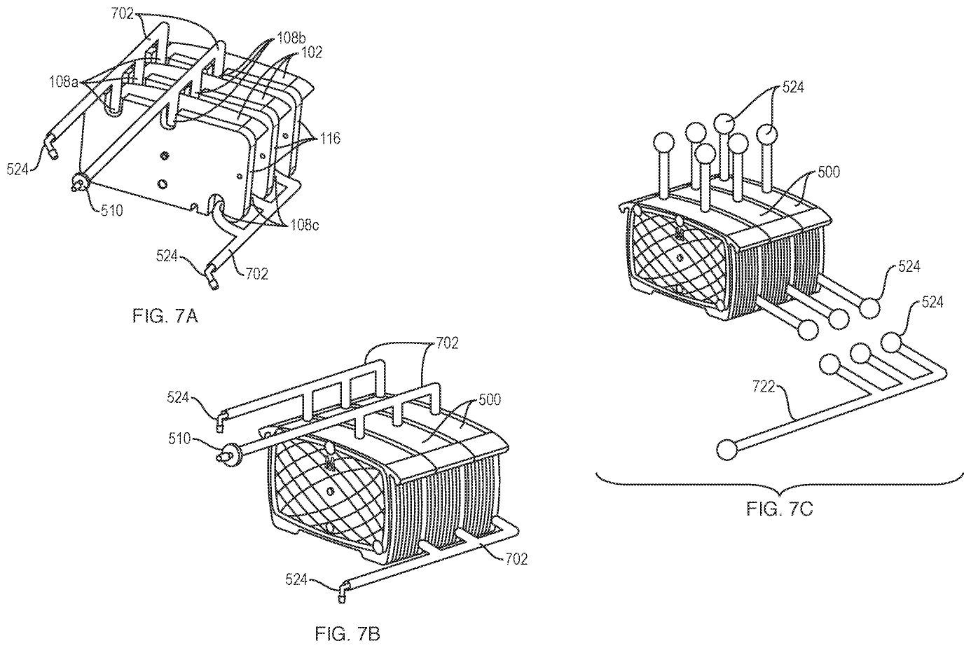

FIGS. 1A-1F depict views of a modular depth filter device, comprising an insert plate, connectors, and a process scale pod, according to embodiments of the disclosure. The modular depth filter device 100 shown is a process scale pod 102 having on or more add-on components 104 (e.g., as shown in FIG. 1A). The modular depth filter device 100 is closed from the environment during the entire use cycle of the device and enables the aseptic connection and disconnection of this device for closed processing applications. FIG. 1A shows a blind end component 104a and a 90° elbow hose barb connection component 104b. In some embodiments, there is a rim 105a, 105b for each component (rear side shown in FIG. 1A). In FIG. 1B, the blind end component(s) 104a are attached to pod 102, which has 6 port openings 108 (such as 108a, 108b, 108c) in total (as shown, three ports on a rear face (not shown) in fluid communication and opposite to three ports on a front face 110). Three hose barb fitting or connector(s) 112, at a terminal end of hose barb connection components 104b are attached to the three front openings while blind end components 104b are attached to the three rear openings by any suitable plastic joining method. The blind end components can be attached to either side. For example, instead of three hose barbs on one side and three blind components on the other side, it could be that two hose barb and one blind components are on one side, and one hose barb and two blind are on the other side. Having blind components all on one side can make one side look flat. For example, plastic joining methods include, but are not limited to, solvent bonding, vibration welding, laser welding, and induction welding techniques. A 90° elbow hose barb connection component 104b may also be attached by spin welding due to the circular geometry of the interface. Tubing 114b (e.g., silicone or C-Flex® (Saint Gobain)) is installed onto each hose barb connection and a sterile-to-sterile connector 114a (e.g., AseptiQuik® G (Colder Products Corp.), ReadyMate™ disposable aseptic connectors (Cytiva), LYNX® S2S Connector (manufactured by EMD Millipore Corporation), KLEENPAK® Presto sterile connectors (Pall Corp.), and PURE-FIT® SC (Saint Gobain)) is attached to the end of the tubing 114b as in FIG. 1C (aseptic connectors 114a are shown as cubes). The type of aseptic connector component can be chosen depending on application, tubing size, sterilization method compatibility, etc. Alternatively a blind end component 104a and a 90° elbow hose barb connection component 104b can be integrated into each end plate during the injection molding of those parts (see FIG. 5 and FIG. 6 below). Alternatively, instead of hose barb fittings in FIG. 1, FIG. 5, FIG. 6, tri-clover or tri-clamp sanitary fittings can be used. In addition, instead of 90° in the elbow hose barb fittings in the component 104b, other angles such as 135° or 180° (or straight hose barb) can be used. The filter device 100 with tubing 114b and aseptic connectors 114a are considered as one module, which is to be packaged and sterilized (or bioburden-reduced) before use (e.g., gamma irradiation, X-ray irradiation, electron-beam/beta irradiation, ethylene oxide, vaporized hydrogen peroxide, nitrogen dioxide, vaporized peracetic acid, or autoclave).

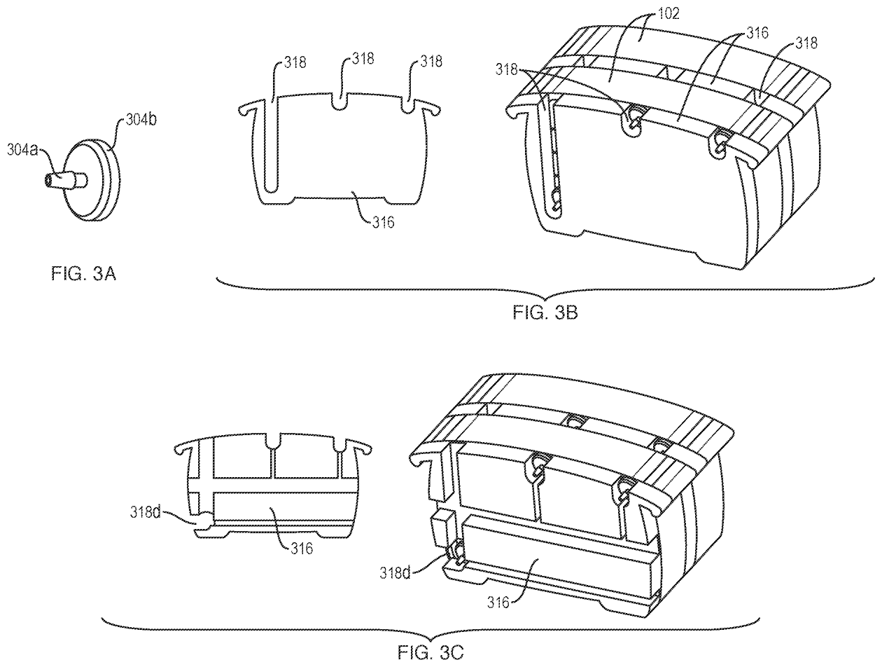

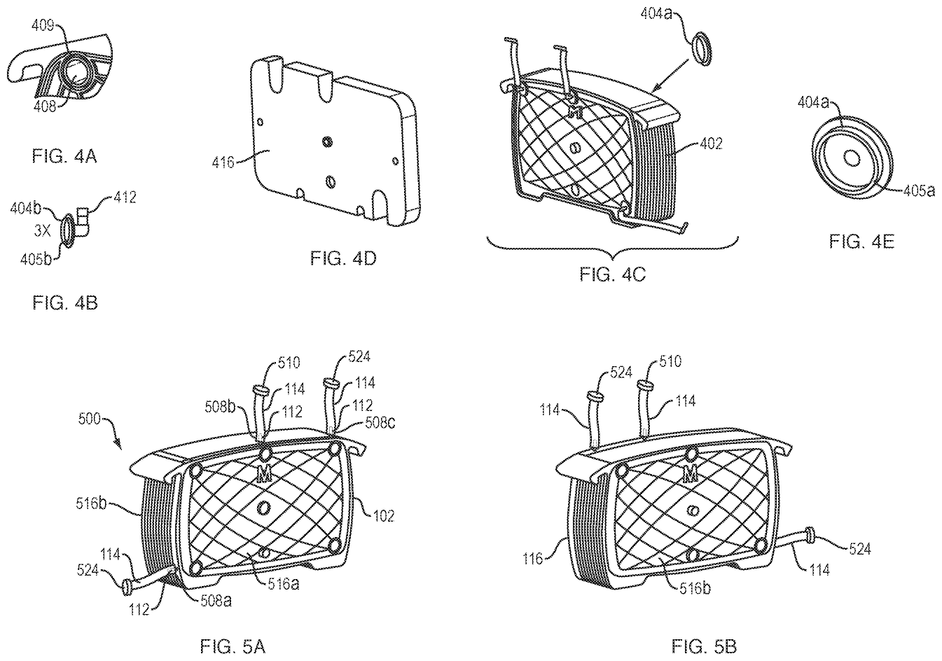

As shown in FIG. 1C, the orientation of each of 90° elbow hose barb connector 112 can vary. For example, the hose barb connector 112 can face down with respect to any port opening 108a, 108b, 108c, which may be an inlet, e.g., 108a, upwards for a vent port, e.g., 108b, and right facing for an outlet port, e.g., 108c. Other orientations of the hose barb connectors are possible (see FIG. 3 and FIG. 4). Typically, the vent port comprises a barb connector 104b that is facing up to facilitate air removal. FIG. 1D shows an insert plate 116 and the location and geometry of each slot 118a, 118b, 118c in the insert plate correspond to each of the hose barb connectors 104b. The insert plate 116 as shown in FIG. 1D has one port at each side (i.e., top, left, and right), which helps an end user easily identify from which port each tubing piece and its associated aseptic connector originates. The insert plate 116 may be made of plastic, metal, ceramics or combinations thereof. The insert plate 116 is a separate part, which is single-use or reusable, and is not bonded to the filter device 100 as shown in FIG. 1E. The insert plate 116 has a suitable thickness to contain and protect the hose barb connectors and their associated tubing. That is, when the insert plate 16 is in the assembled condition attached to a face of the pod 102, the location and configuration of each of the slots 118a, 118b and 118c in the insert plate 116 causes the hose barb connectors and associated tubing to be recessed within the thickness of the insert plate 116. FIG. 1E inset 120 shows the hose barb connector 104b at the outlet location when the insert plate 116 is placed in contact with an end plate of an adjacent filter device. Depending on the size of hose barb connector 104b and/or the weight of each insert plate 116, additional insert plates 116 (not shown) can be placed between two filter devices 102 to create room for a hose barb connector 104b. The purpose of the insert plate 116 is to contain and protect the hose barb connectors 104b and tubing 114 (such as 114a, 114b, 114c) when multiple filter devices are stacked together for full scale operation. Without the insert plate 116, the hose barb connectors 104 and attached tubing 114 can become damaged, pinched, or inoperable as intended when the devices 102 are compressed together in a holder hardware during operation using a press, for example, a hydraulic pump.

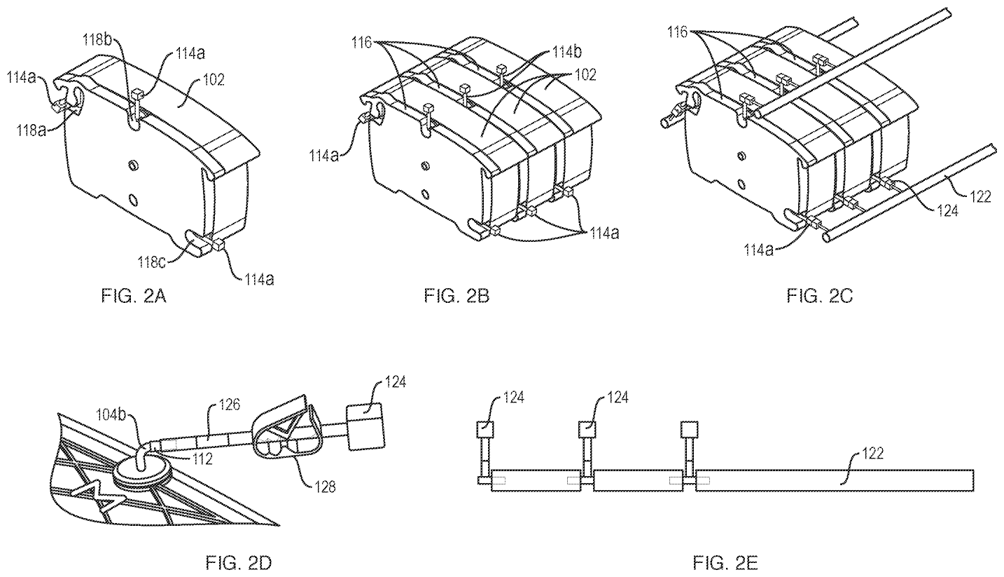

FIGS. 2A-2E depict a plurality of modular depth filter devices, comprising an insert plate, connectors, and a manifold(s), according to embodiments of the disclosure. In FIG. 2(A), a filter device 102 and insert plate 116 are positioned in a manner such that all hose barb connectors 114a are aligned with respective slots 118a, 118b and 118c in the insert plate 116. As an illustration, a configuration containing three filter devices 102 is presented in FIG. 2B. Multiple filter devices 102 are stacked together with a plurality of insert plates 116 adjacent to the filter devices 102. A holder is not depicted here for visual simplicity. Multiple sets of pre-sterilized (or bioburden-reduced) filter devices 102 may then be placed in a Pod holder rack (not shown). A corresponding number of insert plates 116 are placed between each of the pre-sterilized filter devices 102. Each insert plate 116 contains alignment key features on each side to be matched with corresponding opposite pattern of the adjacent holder plate or filter device 102 so that it can be placed only in one direction/orientation, as discussed above. A pre-sterilized manifold tubing 122 assembly is introduced. The pre-sterilized manifold tubing 122 has aseptic connectors 124 attached. The aseptic connectors 124 of the manifold assembly 122 are connected to the corresponding aseptic connectors 114a attached to the pre-sterilized filter devices 102 as shown in FIG. 2C. The manifold tubing 122 can be molded or constructed using tubing, tees, reducers, and/or 90° elbow connectors (FIG. 2E).

In some embodiments, only one manifold tubing 122 is placed at each side of the filter device 102, but it is to be understood that additional variations are possible depending on the length of tubing connected to each port of filter device 102 and the layout of the slots in the insert plate 116. For example, the length of the tubing 114b attached to the inlet ports could be long enough for the connected manifold assembly 122 to be located on the upper side of the filter devices 102, alongside the manifold assembly connected to the vent ports (discussed above). Multiple pre-sterilized or bioburden-reduced (e.g. gamma- or X-ray-irradiated or ethylene oxide-exposed) depth filter devices can be aseptically connected and/or disconnected. Other modes having pre-combined filter devices are also described below.

For dripless disconnection/disassembly, an irreversible pinch-pipe type crimp solution 126 (e.g. NovaSeal™, manufactured by EMD Millipore Corporation), reversible pinch clamp 128, and/or thermal welding can be implemented (a pinch-pipe and a pinch clamp are illustrated in FIG. 2(D)). Alternatively, other disconnection devices can be used such as QuickSeal® disconnect (Sartorius), Clipster® Aseptic Disconnector (Sartorius), AseptiQuik® DC (Colder Products Company), HFC39 (Colder Products Company), HFC Disconnect (Colder Products Company), Kleenpak™ Sterile Disconnector (PALL), SeriesLock™ (Eldon James) and Lynx® CDR (EMD Millipore Corporation). Previous Pod designs required a compression force of up to 1000 PSI, applied from the hydraulic pump installed in Pod holder to create a fluid-tight seal between the two adjacent flat seal gaskets as well as to provide structural support for the multiple pressurized Pod filter devices (up to, for e.g., 50 PSI) during operation. However, with the novel embodiments presented here, there are no flat seal gaskets and an external tubing manifold is used to provide fluid tight seals between adjacent pod devices. As a result, compression from a hydraulic pump is only used to give structural support to the pressurized filter devices 102 and there is, therefore advantageously, no need to create fluid-tight seals between two adjacent filter devices 102.

FIGS. 3A-3C depict a plurality of modular depth filter devices, comprising an alternative insert plate and alternative connectors, according to embodiments of the disclosure. Instead of a 90° elbow hose barb connector 104b, a straight hose barb connector 304a on a circular base portion 304b can be used, as shown in FIG. 3A. For some embodiments, the thickness of one insert plate 316 (or the combined thickness of multiple insert plates 316) adequately prevents kinking of the tubing (not shown) connected to the straight hose barb connector 304a when directed upward by the insert plate 316, as shown in FIG. 3B. That is, in some embodiments, all or a portion of the tubing is recessed in a through-slot 318 of the insert plate 316, protecting it from contact with other components or materials that could damage it. Various configurations of the insert plate 316 are possible by changing the layout of the slots 318 as shown in FIG. 3B and FIG. 3C. In FIG. 3B, the slots 318 direct the tubing from all three ports toward the upper side. In FIG. 3C, the end user is provided with several options for tubing layout from each port as long as sufficient tubing length is provided for each port. For example, slot 318d allows an end user to direct tubing in three different directions. As shown, tubing could traverse the plate 316 upwards, to a left orientation, and/or a right orientation.

FIGS. 4A-E depict perspective views of a modular depth filter device, comprising a second alternative insert plate, connectors, and blind end components, according to embodiments of the disclosure. Three 90° hose barb connector 404b (FIG. 4B) and three blind end component(s) 404a (FIG. 4E) are attached to a process scale Pod (PSP). The PSP has a recessed annular space 409 around each opening 408 (FIG. 4A). A hose barb connector 404b or blind end component 404a is attached to each opening 408 such as by spin welding. The rear sides of these components have a rim 405a, 405b, which is shaped to form a ‘butt weld’ configuration of spin welding (as shown in FIG. 4E). Equipment capable to spin weld these components include VORTEX® PRECEDENCE™ servo-driven spin welder (Extol, Inc., Zeeland, Mich.) and Servo Weld™ Plus Spin Welder (Dukane Corp., St. Charles, Ill.). Once the components are attached, other components are connected: vent filter (e.g., Gamma Phobic Opticap® XL 50 Express® SPG 0.2 and Gamma Phobic Opticap® XL 300 Express® SPG 0.2), pre-cut tubing (e.g., silicone or C-Flex®) and sterile-to-sterile connectors (e.g., AseptiQuik® G (Colder Products Corp.), ReadyMate™ disposable aseptic connectors (Cytiva), LYNX® S2S Connector (EMD Millipore Corporation), KLEENPAK® Presto sterile connectors (Pall Corp.), and Pure-Fit® SC (Saint-Gobain)). The size (tubing internal diameter) of hose barb fitting 412 may range from 0.25 to 1 inch (approximately 6.3-25.4 cm). The insert plate 416 is also shown (FIG. 4D), and serves to stack a plurality of pods 402 within a Pod holder rack (not shown).

### Example of Process Scale Pod (PSP) Integrated with Hose Barb Connectors

FIGS. 5A and 5B each shows at least one embodiment of a PSP 500 with an end plate 516a with three hose barb connectors 112 in fluid communication via tubing 114 for an inlet 508c, a vent 508b, and an outlet 508a, according to embodiments of the disclosure. Also, the PSP comprises a sterile-to-sterile connector 524 on the inlet 508c, a vent filter 510 on the vent 508b, and a sterile-to-sterile filter 524 on the outlet 508a. A second end plate 516b opposite the first end plate has no openings. In FIG. 4, insert plates were utilized to protect the hose barbs and tubing connections from damage while the PSP devices were compressed within the steel holder. Unlike a previous example in FIG. 4, an insert plate 116 is not needed since hose barb connectors are located at an outer side of the end plate 516a, which contributes to a smaller footprint. In this embodiment, the hose barbs and tubing connections are not located in an area where they would be damaged when the PSP devices are compressed within the steel holder, as a result the insert plates between PSP devices are not required. Thus, during assembly the holder approaches from a plane perpendicular to the plane of the face of the end plate 516a, and avoids contact with the hose barb (or other) connectors attached at an outer side as shown in FIGS. 5A and 5B. Instead of hose barb connectors, tri-clover or tri-clamp sanitary fittings can be placed in an end plate 516a.

FIGS. 6A-E depict two embodiments of end plates, according to some embodiments of the disclosure. FIG. 6A depicts an end plate 600 having a plurality of tubing hose barb connectors 604a having an inner diameter of, for e.g., 0.5 inches, approximately 1.27 cm (other sizes, such as 0.25 to 1.0 inch inner diameter, can be used according to embodiments of the disclosure). FIG. 6B is an inset of FIG. 6C and shows that a plate 602 with hose barb connectors 604b placed in fluid communication with integral port area 606, wherein the hose barb connector 604b projects out of the plate 602. The hose barb connectors 604b may be screwed into the end plate 602 or be an integral part (i.e., unable to be removed without destruction of the end plate 602). As shown in FIGS. 6D and 6E, the hose barb connector 604c is in recessed area 608. The recessed area 608 protects the hose barb connector 604c. In some embodiments, the integrated hose barb connectors 604b are glued permanently into the recessed areas 606, heat bonded thereto, or injection molded as a single component. Some embodiments comprise both styles of hose barb connectors 604a, 604b. Instead of hose barb connectors, tri-clover or tri-clamp sanitary fittings can be placed in the end plate 602.

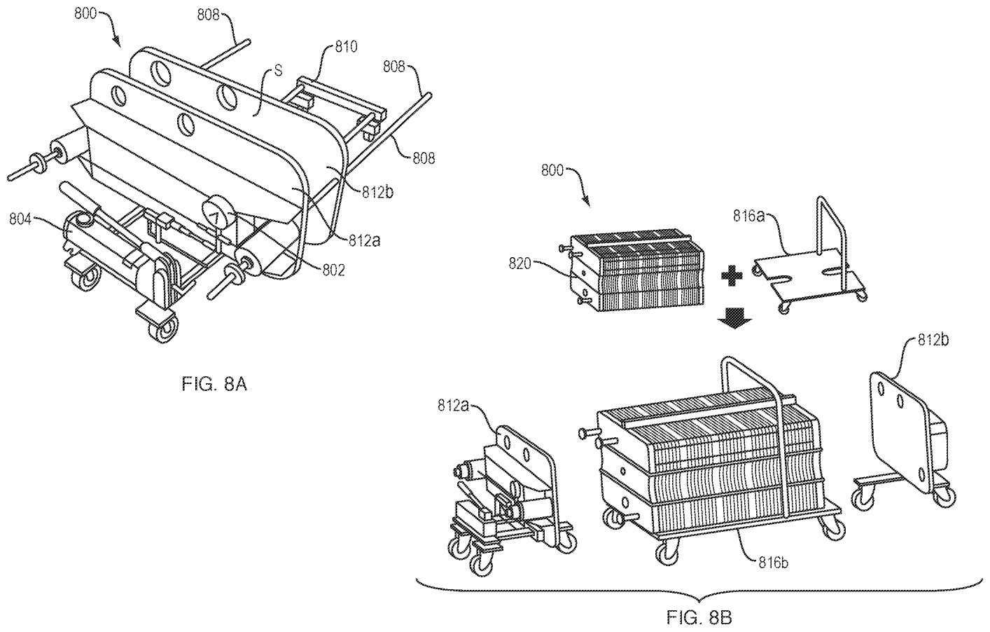

To increase the depth filter area, multiple PSPs may be releasably or permanently joined using manifold assemblies. FIGS. 7A-C depict some embodiments of three PSPs 102, 500 joined using manifold assemblies, according to embodiments of the disclosure. A plurality of PSPs 102 can be joined or pre-connected and sterilized as in FIG. 7A. A plurality of PSPs 500 can be joined or pre-connected and sterilized as in FIG. 7B, as shown, three PSPs are joined. In practice, two PSPs 102, 500 could be joined or ten or more PSPs 102, 500 could be joined. FIG. 7A shows the PSPs 102 between a first insert plate 116 and a second insert plate (not shown) opposite the first insert plate 116, as described above. The three PSPs 102, 500 have inlets 108a, outlets 108c, and vents 108b, as described above. The inlet 108a terminates at a sterile-to-sterile connector 524, the vent port 108b terminates at, for e.g., a vent filter 510, and the outlet port 108c terminates at a sterile-to-sterile connector 524. The respective inlets from each of the plurality of PSPs 102, 500 are connected via a manifold 702. Similarly, the each of the respective vent ports 108b and outlet ports 108c are connected via two separate manifolds 702. Each of the three manifolds may also terminate at a sterile-to-sterile connector 524. The embodiments depicted in FIG. 7B are similar to those in FIG. 7(A) but further demonstrate that insert plates, e.g., insert plates 116, are not required. The hose barbs project from the sides of the PSPs 500. Alternatively, individual PSPs 102, 500 having sterile-to-sterile connectors 524 may be sterilized, wherein an operator joins a separate pre-sterilized manifold 722 assembly(ies) as shown in FIG. 7C. It is to be understood that, in general, and end plate is an integral part of the PSP. An insert plate is a separate component that is releasably joined to PSPs, acting as a spacer.

Some embodiments within the disclosure enable closed processing for clarification using pre-sterilized or bioburden-reduced depth filter devices. Some embodiments within the disclosure enable closed processing for other unit operations, such as viral filtration or purification. Some embodiments provide individual filter device units or modules with pre-attached tubing and connectors (a modular depth filter device); individual filter device modules that can be shipped, handled, and sterilized; multiple filter device modules that can be aseptically connected and disconnected using aseptic connectors, disconnection devices, insert plates, and manifolds; and/or the easy arrangement of tubing and manifolds by various insert plate design(s). Some practical advantages for manufacturers include that there is minimal or no change to currently offered process scale pods; reusable insert plates; and the use of existing pod holders.

### Multi Part Holder Hardware with a Hand Cart for Pre-Combined Filter Devices

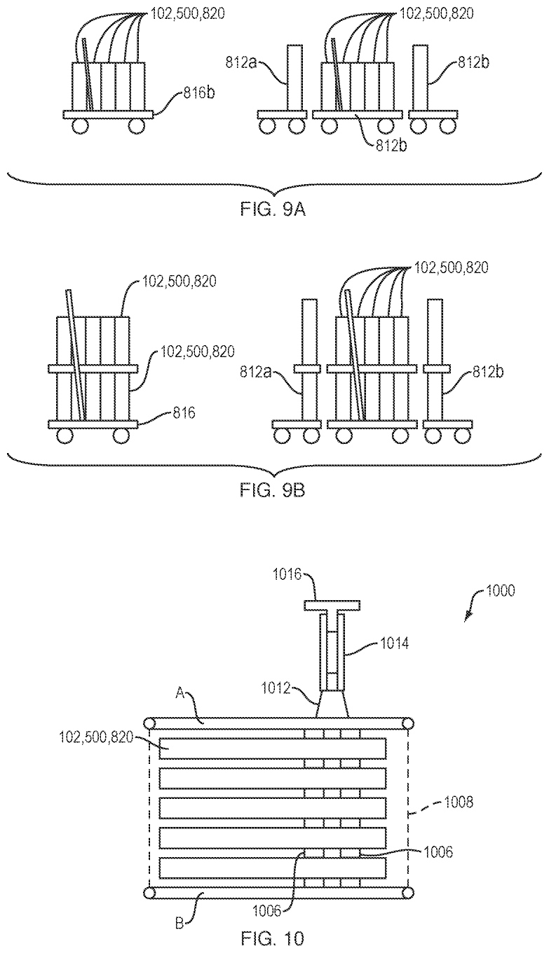

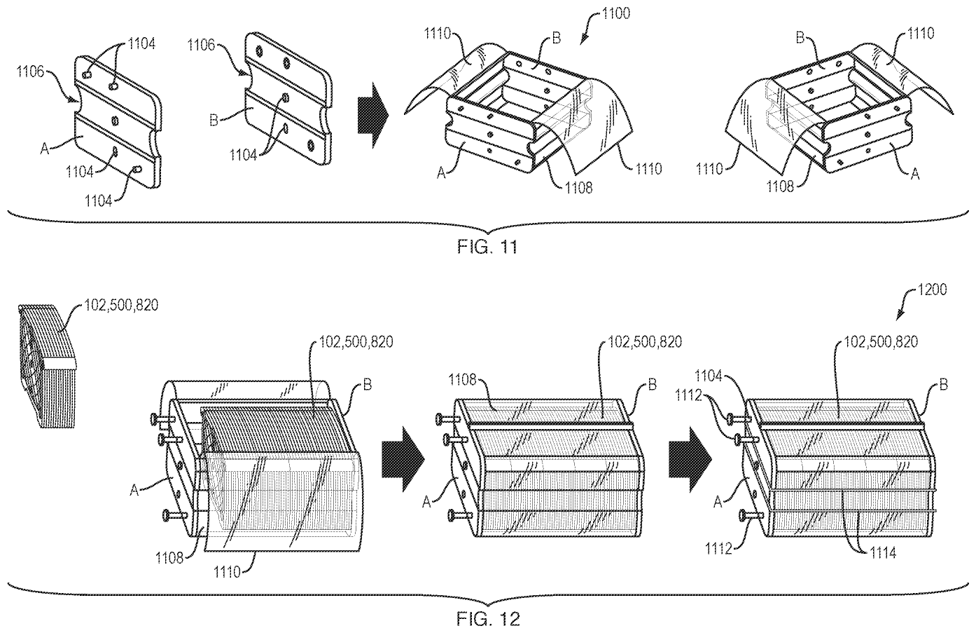

A pre-combined pod filter format comprises comparatively fewer sterile-to-sterile connections, which are made by an operator. Pre-combined formats are heavy (e.g., >50 pounds, approximately 23 kg.). FIGS. 8A and 8B depict an assembly of at least one approach for joining a plurality of filter devices, according to some embodiments of the disclosure. FIG. 8A shows an embodiment wherein the pre-combined pod devices are loaded onto a hand cart and the holder hardware has two separated parts, a side A and a side B. The cart enables short-distance transportation within a biomanufacturing suite without a forklift, crane, or hoist. The holder hardware 800 is depicted in FIG. 8(A), which is designed to load each process scale pod, as discussed herein, individually. The holder hardware 800 comprises a pressure gauge 802, a hydraulic pump 804, a clamp rod 808, a frame 810, and platens 812a, 812b, wherein a space S is disposed therebetween, which can accommodate a plurality of filter devices for compression. The plurality of filter devices can be the devices 102, 500, 820, and all other filter devices as described herein. In FIG. 8B, the holder hardware 800 has two platens 812a, 812b and a plurality of pre-combined PSP devices are loaded into an empty cart 816a to make a full cart 816b, according to embodiments of the disclosure. The number of PSPs 820 to be pre-combined depends on desired applications and/or facility layout. For example, if the depth of a material airlock of a biopharmaceutical production facility is 44 inches (e.g., the depth of airlock ranges 44″ to 72″ (approximately 111 cm to 183 cm); e.g., see https://www.terrauniversal.com/cleanroom-airlocks.html) and each filter device has a thickness of approximately 4.8 inches (12.2 cm), up to, for e.g., ten devices can be combined to enter the biomanufacturing suite. More PSPs 102, 500, 820 can be pre-combined and loaded onto the cart 816b if a multi-rack approach is used. FIGS. 9A and 9B depict multi-rack of process scale pods, according to some embodiments of the disclosure. For example, as shown in FIG. 9A, wherein a single rack (A) of PSPs 102, 500, 820 are shown on the cart 816b in an exploded view between the pressure platen 812a and the pressure platen 812b. In FIG. 9B, a double rack (B) of two stacks of PSPs 102, 500, 820 is depicted on a cart 816b between two taller platens 812a, 812b. In some embodiments, three or four stacks of PSPs 102, 500, 820 are stacked on a cart 816b, i.e., a total of 30 to 40 PSPs 102, 500, 820 are loaded on a single cart 816b. It is to be understood that the PSPs 102, 500, 820 can be in a lab scale configuration, i.e., one PSP 102, 500, 820; a pilot scale, e.g., two to ten PSPs 102, 500, 820 joined and in fluid communication with each other; and a process-scale configuration, i.e., fifteen to forty PSPs 102, 500, 820 in fluid communication, wherein from five to ten PSPs 102, 500, 820 are joined and in fluid communication, i.e., a pilot scale configuration, and stacked with other similar pilot scale configurations. Such a modular and flexible format allows pre-filtration and/or clarification of fluids from, for e.g., 5 L to 15,000 L or more scalability as needed for a process while providing a small footprint.

### Pre-Combined Filter Devices in a Container Made of Hard Bases and Plastic Film

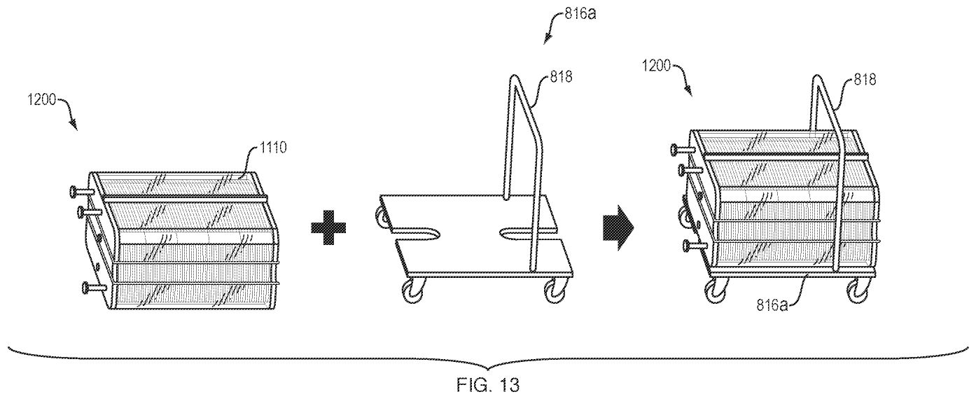

In some embodiments, wherein a plurality of filter devices 102, 500, 820 form a pre-combined configuration, a sterile barrier can be created using rigid bases (e.g.; the bases made from LDPE, HDPE, ABS, nylon), and a polymer/plastic film (e.g., LDPE, copolymers of LDPE, composite films, e.g., PureFlex™ film, and/or ULTIMUS® film, both of which are marketed by EMD Millipore Corporation, Burlington, Mass., USA, which are laminated films having woven or non-woven substrates, and layers of LDPE, ethylene vinyl acetate, ethylene vinyl alcohol, and/or other polymers suitable for bioprocessing). FIG. 10 depicts at least one embodiment of a container 1000 comprising two hard bases A, B and a plastic film 1008, wherein only one hose barb of a pod is shown for illustrative purposes. The plastic film 1008 seals, e.g., hermetically, the PSPs 102, 500, 820 from the environment. In some embodiments, the plastic film 1008, at opposite ends thereof, seals to the hard bases A and B as shown in FIG. 10. These seals can be formed by means known in the art, such as thermal welding. One of the hard bases (side A) has a protruded hose barb fitting 1012, which is connected to tubing 1014 and a connector 1016, e.g., a sterile-to-sterile connector. A plurality of PSPs 102, 500, 820 have seals 1006 disposed between each PSP 102, 500, 820.

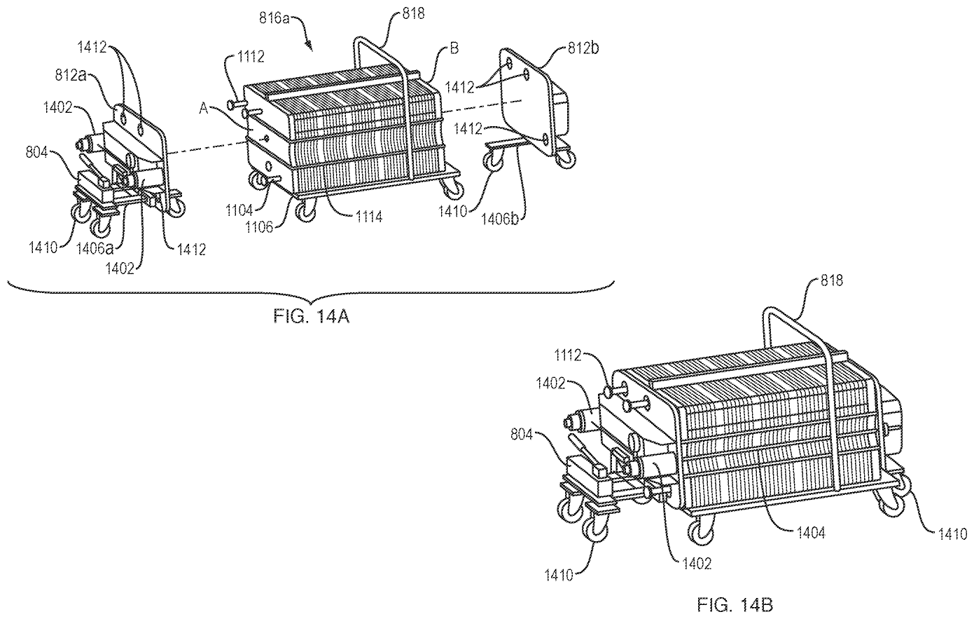

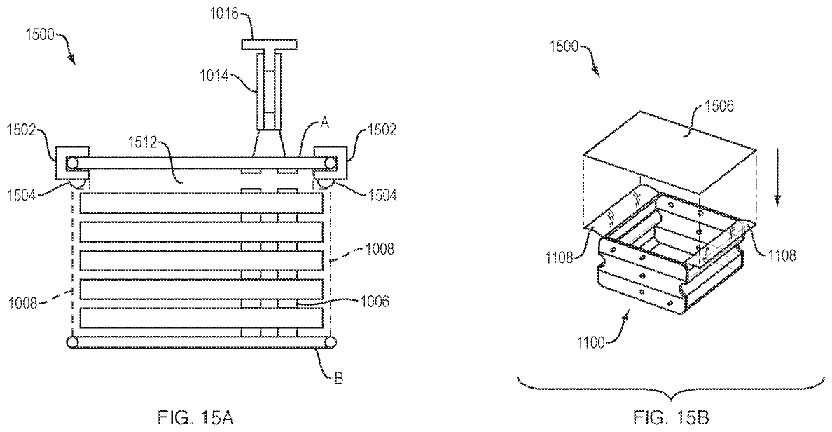

FIG. 11 depicts a container 1100 having a plastic film 1108 thermally welded, bonded or otherwise joined to at least part of a perimeter of hard bases A, B, which optionally comprises overhangs 1110. The hard base A comprises an alignment key(s) 1106 and hose barb connectors 1104. The hard base B comprises alignment key(s) 1106. Each PSP 102, 500, 820 has at least one alignment key feature(s) 1106 at the end plates (see ‘L’ or ‘R’ side in FIG. 6A-6B) and the stainless-steel end plates of the holder hardware also have at least one alignment key feature(s), as discussed above. The alignment key feature(s) 1106 are present in both the front and rear sides of each hard base A, B to be aligned with the pods and the end plates of the holder. FIG. 11 depicts the location of alignment keys 1106, which are present at both sides in each hard base. A plurality of sterile-to-sterile connectors 1112 in FIG. 12 are attached to the three locations of the hose barb connectors 1104. The container 1100 is thermally sealed by folding the overhangs 1110 over the top of the assembly and using, for example, impulse heat sealers having PSPs 102, 500, 820 to form a pre-combined pod 1200. Alternatively, sterile-to-sterile connectors 1112 can be releasably joined or attached after the container 1100 is thermally sealed by the films 1108. Additionally, strapping or banding 1114 may be used to further stabilize or retain the contents in a container 1100. Hard bases A, B may further comprise grooves (not shown) to facilitate a location of the strapping bands.

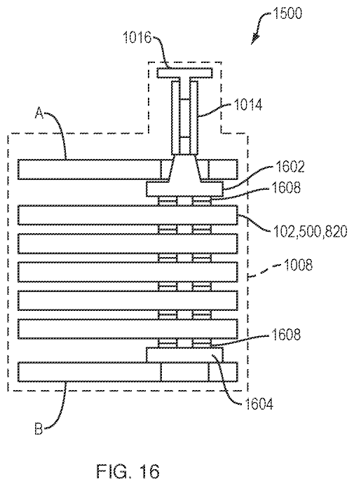

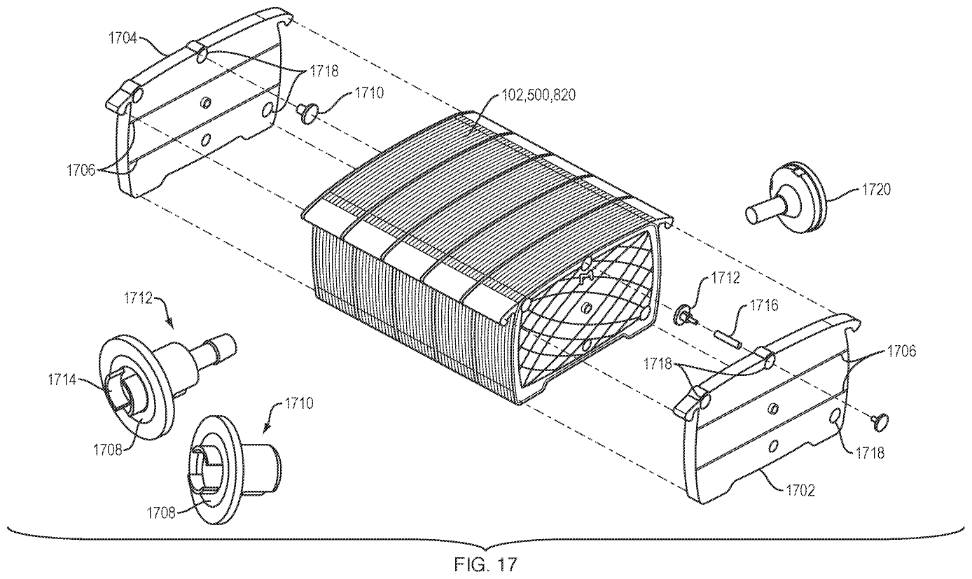

FIG. 12 depicts a plurality of PSPs 102, 500, 820 enclosed in container 1200, according to some embodiments of the disclosure. Plastic film overhangs 1110 in FIG. 11 are thermally sealed after a plurality of filter devices or PSP 102, 500, 820 are loaded. FIG. 13 depicts a plurality of PSPs 102, 500, 820 enclosed in the container 1200, disposed on a cart 816a, according to some embodiments of the disclosure. Plastic film overhangs 1110 are thermally sealed after a plurality of filter devices or PSP 102, 500, 820 are loaded. The pre-combined pods 1200 may be loaded onto a hand cart 816a. Optionally, the loading of the pre-combined pods 1200 into a container 1100 can be done after a container 1100 is preloaded onto the cart 816a. A handle 818 may be placed after a container 1100 is sealed and strapped. A cart 816a and a container 1100 can be integrated to make the whole assembly disposable, or a cart 816a can be reusable if, for example, the container 1100 is separated from the cart 816a after use. The cart 816a having the PSPs 102, 500, 820 can then be delivered between the pressure platen 812a and the pressure platen 812b (FIG. 14A) for providing pressure during operation.

In some embodiments, a plurality of sterile connections is made between the depth filter devices 102, 500, 820. Depth filter devices include, but are not limited to, MILLISTAK+® HC Pods, MILLISTAK+® HC Pro Pods, CLARISOLVE® Pods as manufactured by EMD Millipore Corporation or other flat-plate filtration cassette devices such as SARTOCLEAR® Depth Filters, manufactured by Sartorius Stedim. Sterile connections may be made using a ‘connector plate’ component. For example, a connector plate may comprise female couplings. In some embodiments, the female couplings are LYNX® S2S style, manufactured by EMD Millipore Corporation. Each Pod or depth filter device may have male couplings, for example, LYNX® S2S style male couplings, at six openings (two for an inlet, two for a vent, and two for an outlet). Sterile-to-sterile connection devices, such as the connectors of the type described in U.S. Pat. No. 7,137,974 B2 (the entire disclosure of which is herein incorporated by reference) and, for example, the connectors depicted in FIG. 3, FIG. 4, and/or FIG. 5 of U.S. Pat. No. 7,137,974 B2, may be used.

FIGS. 14A and 14B depict the hard base A, B of FIGS. 12-13, according to embodiments of the disclosure, further comprising clamp rods. The hard base A comprises the alignment key(s) 1106 and the hose barb connectors 1104. The hard base B comprises the alignment key(s) 1106. The plurality of filter devices or PSP 102, 500, 820 are loaded, as depicted in FIG. 12. The alignment key feature(s) 1106 are present in both sides of each hard base A, B to be aligned with the pods and the end plates of the holder. The plurality of sterile-to-sterile connectors 1112 are attached to the three locations of the hose barb connectors 1104.

In some embodiments, a cart 816a and two platens 812a, 812b, wherein a space to compress a plurality of filter devices disposed therebetween, are provided. The platens 812a and 812b comprise rails 1406a, 1406b. The rails 1406a, 1406b facilitate alignment with the cart 816a. The two platens 812a, 812b, with the cart 816a therebetween, are brought together and aligned. Optionally, the cart 816a comprises grooves (not shown) to locate the rails 1406a, 1406b. Also, optionally, the platens 812a, 812b optionally comprise casters 1410. Clamp rod knobs 1402 and clamp rods 1404 are separately installed. A hydraulic pump 804 installed in or at one side of the platens 812a, 812b and is used to compress the devices and, optionally, gaskets in the assembly to establish seals between the gaskets. The two platens 812a, 812b each has three, e.g., circular openings 1412 for inlet, vent, and outlet connectors. For example, sterile-to-sterile connectors and tubing pass through the openings 1412. Alternatively, the shape of each opening 1412 can be a slot (similar to those shown in FIGS. 1 to 4) so that only tubing, not an entire cross-section of sterile-to-sterile connector, needs to pass through the slot. The pre-combined pod anywhere described in this disclosure can be sterilized or bioburden-reduced, e.g., by gamma irradiation, x-ray or electron-beam (e-beam)/beta irradiation. However, if a gas-based sterilization method is used, such as ethylene oxide, vaporized hydrogen peroxide, nitrogen dioxide, vaporized peracetic acid, or steam (under controlled conditions), a container should have a breathable area where sterilant gases/steam may penetrate and escape quickly.

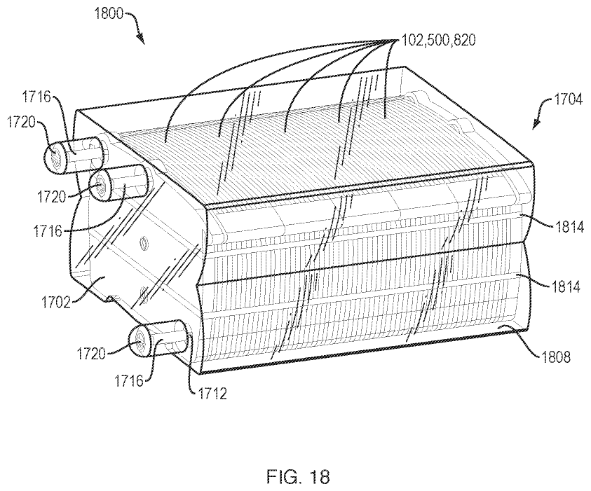

FIGS. 15A and 15B respectively depict a schematic view and a perspective view of the container 1100, further comprising spacers between the pods 102, 500, 820, according to embodiments of the disclosure. FIG. 15A is a simplified schematic illustrating key features of the embodiment. These include multiple PSP devices, and exterior plastic film, end plates (hard bases), an adaptor, and seals as described. FIG. 15A-15B depict a container system 1500 where a plastic film 1108 (e.g., LDPE, PureFlex™ film, and ULTIMUS® film, made by the EMD Millipore Corporation) , is placed on three sides and TYVEK® film 1506, is placed on one side (e.g., a top side) and clips 1502 are releasably joined to a hard base A with spacer or cushioning components 1504 are installed between to create a space 1512 for the ingress and egress of sterilant gases/steam. For example, a container comprising two hard bases A, B and plastic film 1008, tubing 1014 and a connector 1016, e.g., a sterile-to-sterile connector, and the PSPs 102, 500, 820 as depicted in FIG. 10, can be used with the container system 1500. The clips 1502, which are typically removable, will be placed during sterilization and removed during the installation with two platens 812a, 812b. A closed pod with tubing manifold in accordance with some embodiments is depicted. The closed pod/filter device can be seen, for example, as FIG. 15 from International Publ. No. 2020036869A1, the entire disclosure of which is incorporated by reference.

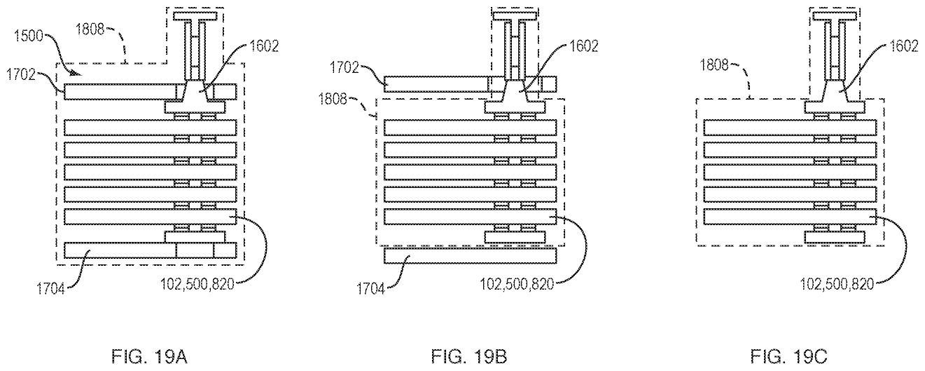

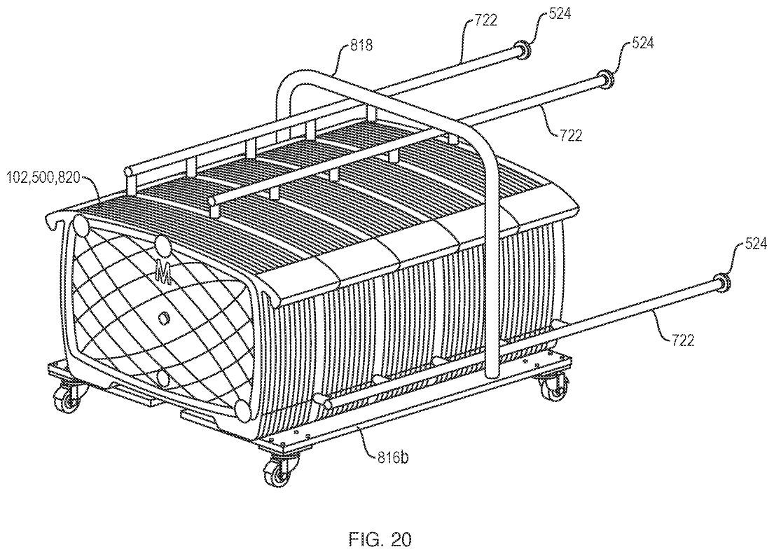

In some embodiments, hard bases A, B and a polymer film 1008 (e.g., LDPE, PureFlex™ film, and ULTIMUS® film, made by the EMD Millipore Corporation) are used to construct a container as shown in FIG. 10. In some embodiments, a container can be made of a polymer film with the other components including hose barb adapters, blind end cap adaptors and end plates as shown in FIG. 16. FIG. 16 depicts a container system 1500, as described above, enclosed in a poly film 1008, further comprising at least one hose barb 1602 and one blind end cap adaptor 1604. FIG. 17 depicts an exploded view of a plurality of PSPs 102, 500, 820, two support plates, a connector, and snap-fit adaptors. As depicted in FIG. 17, each end plate 1702, 1704 has at least one groove(s) 1706 to include strapping bands, as described above. The groove 1706 is similar in function as in the hard bases A, B as shown in FIG. 11. Each hose barb 1712/blind end cap adaptor 1710 has a gasket 1708 and a snap fit connection 1714 to facilitate placement in each opening 1718 of a filter device, for e.g., PSPs 102, 500, 820. An optional tubing 1716 for connecting a hose barb 1712 with a sterile connector 1720 is also depicted.

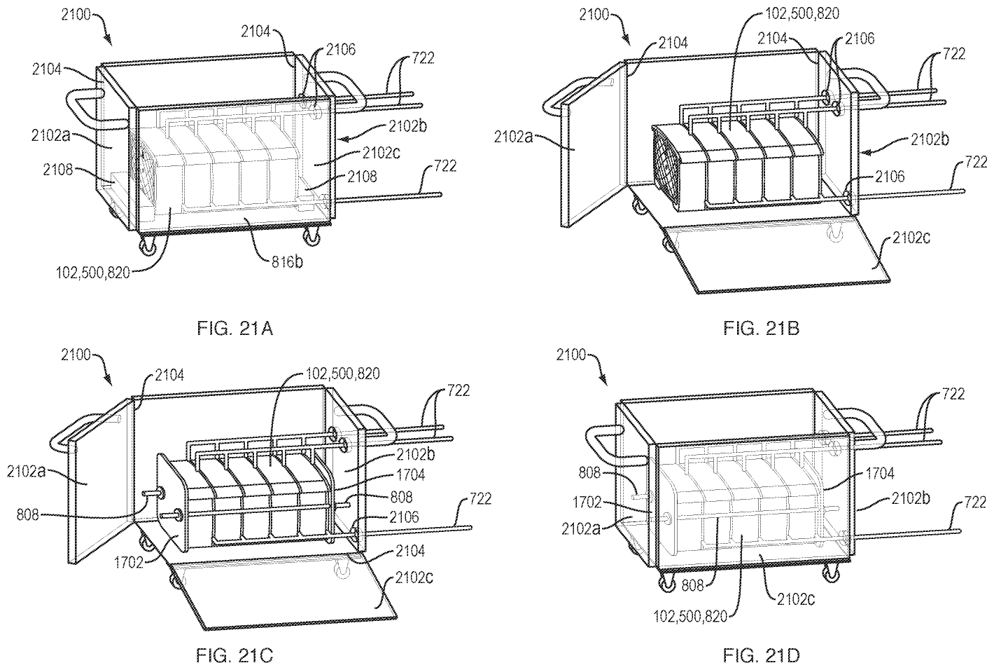

FIG. 18 depicts an assembled container 1800 of the exploded view of FIG. 17, according to some embodiments of the disclosure, further comprising strapping 1814. The assembled container 1800 is typically sterilized and remains sterile while within the polybag 1808. As depicted in FIG. 18, all three hose barb adaptors 1712 are placed on one side of the end plate 1702 and three blind end cap adapters are placed on an opposing side of the end plate 1704 (not shown). In some embodiments, two hose barb adapters (for inlet and vent) and one blind end cap adapter (for outlet) are placed on one side while a hose barb adapter (for outlet) and two blind end cap adapters are placed on the other side.

In FIG. 18, plastic or poly film 1008 as a sterile barrier encloses all the components including sterile-to-sterile connector(s) 1720. Once a hand cart, as described above, is loaded with pre-combined filter devices in, as shown, a poly bag container 1808, it may be combined with two platens 812a, 812b, as in FIG. 14. Two clamp rods, as described above, may be installed to engage the two platens 812a, 812b and the cart (not shown). When compressing the devices using a hydraulic pump, the gasket components will be engaged and create fluid-tight seals between two adjacent PSPs 102, 500, 820 as well as between the adapter components and the PSPs 102, 500, 820. At some point, the three protruding areas in a poly bag container 1808 will be cut open to expose the sterile-to-sterile connectors. Opening the poly bag container 1808 at this time will not compromise the sterility of the PSP assembly, as the fluid tight seals have already been created through compression of the PSP created by the hydraulic pump.

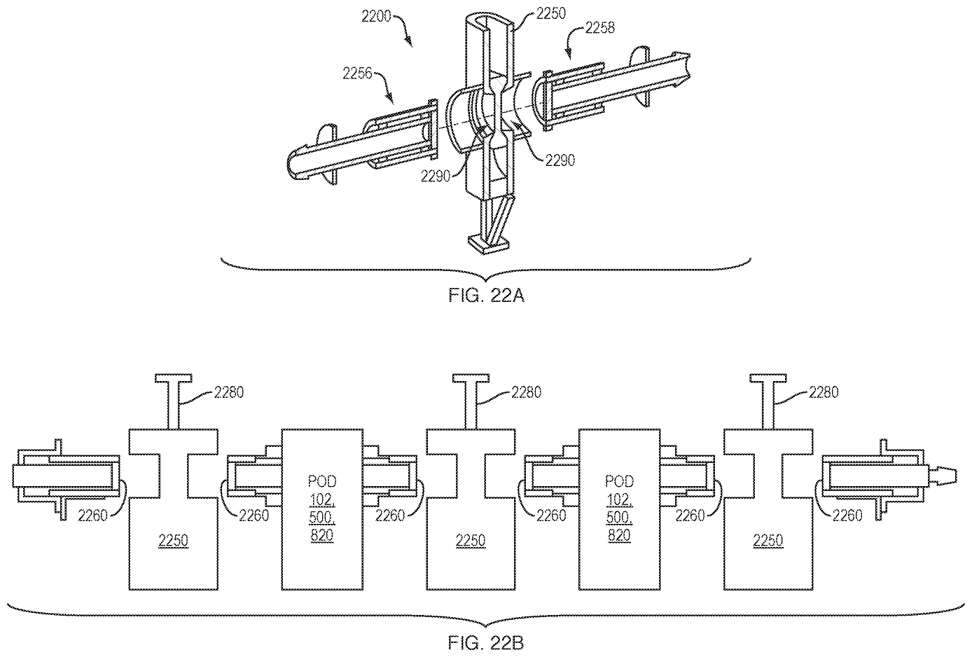

FIGS. 19A, 19B and 19C depict front views of three embodiments of the pods 102, 500, 820 in a poly bag. Three differing embodiments of the poly bag or container 1808 are shown in FIG. 19A-19C, according to embodiments of the disclosure. FIG. 19A is the same as that in FIG. 16, i.e., the container system 1500 is fully encapsulated within the poly bag 1808. FIG. 19B depicts a second embodiment, wherein the support plates, such as end plates 1702, 1704 are outside the poly bag 1808. FIG. 19C depicts an embodiment of the container system 1500 having no support plate(s). Only one hose barb 1602 of each container comprising PSP 102, 500, 820 is shown for ease of illustration. Cushioning or foam materials (e.g., polyethylene closed cell foam, expanded polyethylene (EPE) foam, polystyrene foam, polyurethane foam, and other open- and/or closed-cell foamed polymeric materials) are optionally placed where the poly films are in contact with rigid faces of the devices to prevent tearing or damage of the films.

### A Cart with Pre-Combined Filter Devices with Manifold Assemblies

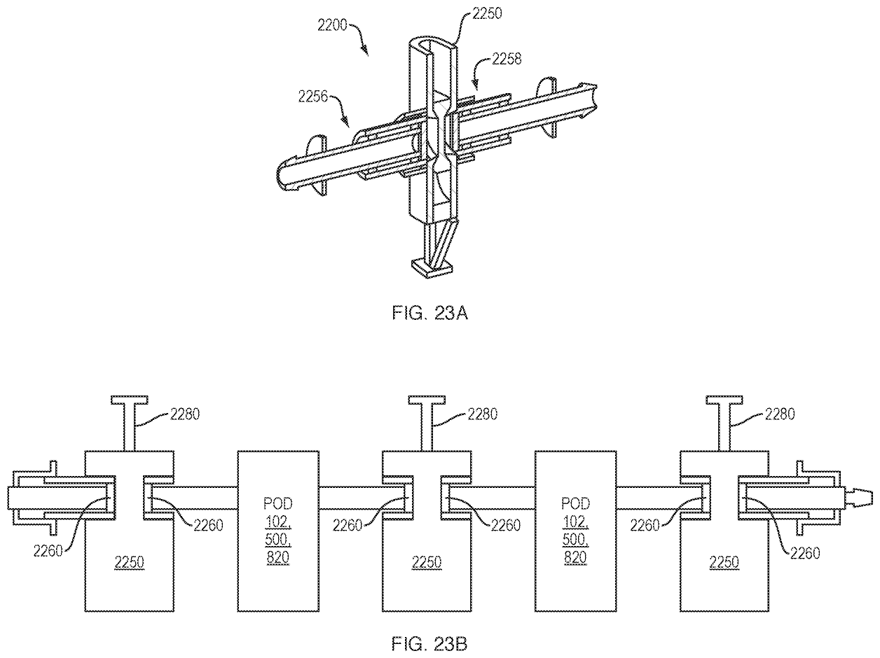

The pre-combined filter devices, described above, may be enclosed in a container and loaded onto a cart. Some embodiments according to the disclosure are depicted in FIG. 20, wherein the device configuration, having five PSPs 102, 500, 820 and manifolds 722, described above, is loaded onto a cart 816b having the handle 818. The individual devices are connected by manifold sets. For dripless disconnection/disassembly of these devices, an irreversible pinch-pipe type crimp solution (e.g. NovaSeal™), reversible pinch clamp, and/or thermal tube welding can be implemented (an example of a pinch-pipe and a pinch clamp are illustrated in FIG. 2(D)). Alternatively, other disconnection devices can be used such as QuickSeal (Sartorius), Clipster Aseptic Disconnector (Sartorius), AseptiQuik DC (Colder Products Company), HFC39 (Colder Products Company), HFC Disconnect (Colder Products Company), Kleenpak Sterile Disconnector (PALL), SeriesLock (Eldon James), and Lynx® CDR (EMD Millipore Corporation). These features allow each device to be disposed of individually in a dripless manner. Manifold assemblies are made of sterile-to-sterile connectors, tubing, tees, reducers, and/or 90° elbow connectors.

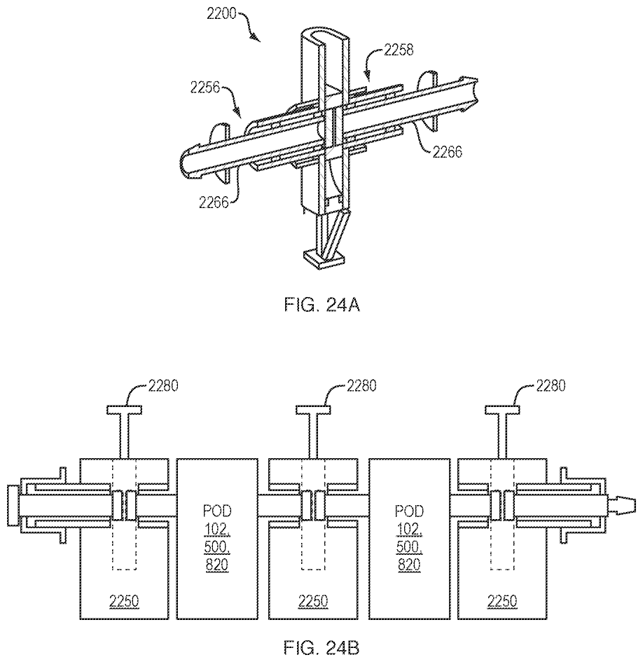

For operations where the maximum operating pressure is limited to below 30 PSI, a simplified holder device 2100 with end support plates 1702, 1704 can be used without a hydraulic pump (as described above). FIGS. 21A-21D depict a plurality of pods in various states of installation within a holder device, according to some embodiments of the disclosure. For example, in FIGS. 21A-D, a cart, such as the cart 816b, is loaded with pre-combined filter devices 102, 500, 820. The cart 816b has openable (or removable) side walls 2102a, 2102b, 2102c, such as by a hinge or living hinge 2104, some of which are open during the installation of end support plates 1702, 1704 and clamp rods 808. The side walls 2102a, and 2102c can be closed during a filtering operation. For the sake of clarity, a top wall is not shown. It is to be understood that, optionally, a top may be included and closed with the sidewalls 2102a, 2102b, and 2102c. Once the filtering operation is complete, the end support plates 1702, 1704 and clamp rods 808 are removed, and the filter devices 102, 500, 820 can be disposed of. The cart 816b may be single-use or multi-use. FIG. 21A depicts the cart 816b having the filter devices 102, 500, 820 placed thereon. As depicted, there are five filter devices 102, 500, 820, although any suitable number of filter devices 102, 500, 820 may be employed. The manifolds 722, joined to the filter devices or pods 102, 500, 820 as described above, may extend through the sidewall 2102b at windows 2106. The simplified holder device 2100 can then be moved to, for e.g., a cleanroom or other suitable location. Also depicted are, optionally, two stoppers 2108 disposed between the filter devices and the sidewalls 2102a and 2102b, which keep the filter devices 102, 500, 820 in place during transportation. FIG. 21B depicts the simplified holder device 2100 containing the filter devices 102, 500, 820 therein, wherein the sidewall 2102a and 2102c are opened. The stoppers(s) 2108 are removed for this step. FIG. 21C depicts the simplified holder device 2100 containing the filter devices 102, 500, 820 therein, wherein the sidewall 2102a and 2102c are opened and the end support plates 1702, 1702 and the clamp rods 808 installed. FIG. 21D depicts the simplified holder device 2100 containing the filter devices 102, 500, 820 therein, having the end support plates 1702, 1702 and the clamp rods 808 installed, wherein the sidewall 2102a, 2102b, and 2102c are closed and ready for a filtering operation.

### Connector Plate Approach

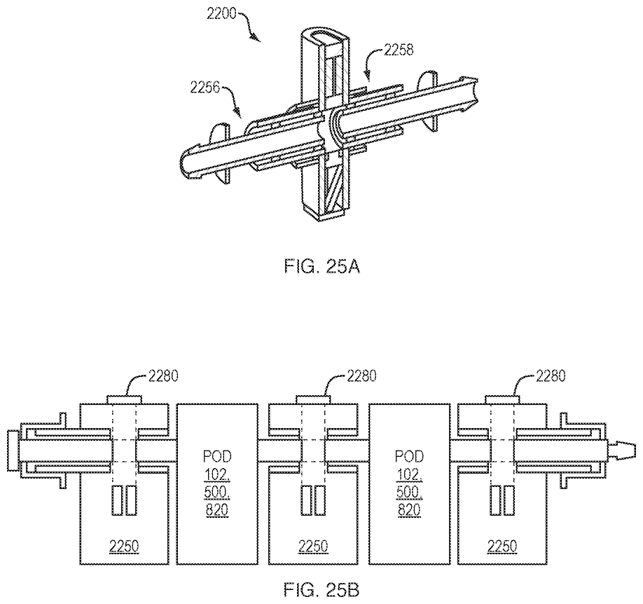

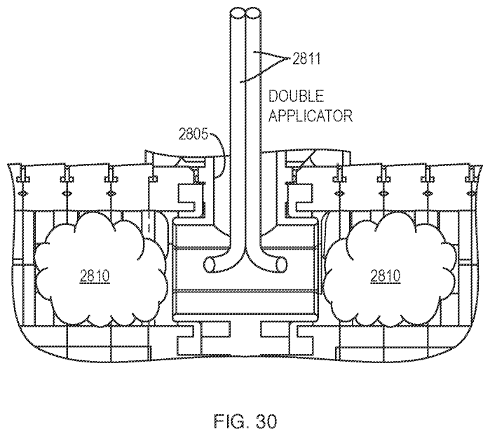

FIGS. 22-26 depict steps for making sterile connections between filter devices or pods. The process for making sterile connections between pod and filter devices are described in FIGS. 22 to 26 below using a fluid transfer device 2200, e.g., a connector or a sterile connector. These figures depict how the connector plates 2250 and the pods 102, 500, 820 are connected step-by-step. In FIGS. 22A and 22B, the connector(s) 2250 and two coupling devices 2256, 2258 are shown in their closed unassembled state. Coupling devices may already have been connected to another component (not shown) via a second opening 2270 and stems 2266 (shown below in FIG. 27) and sterilized, e.g., by gamma or X-ray irradiation, gases such as ethylene oxide, steam or the like.

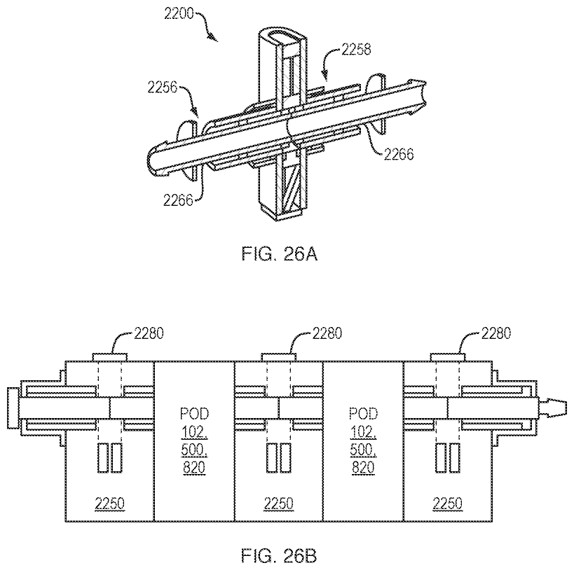

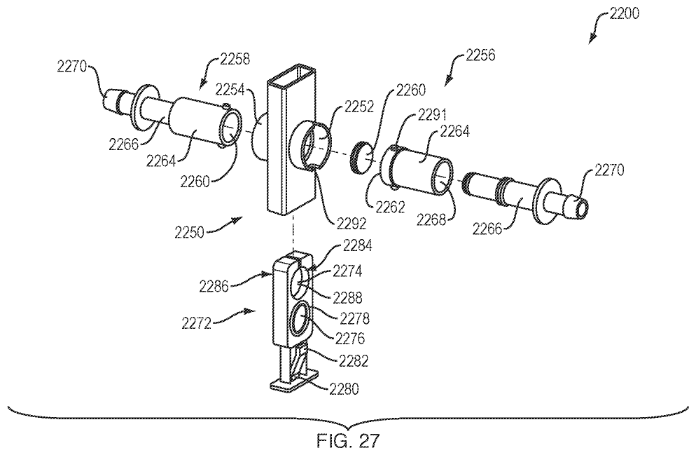

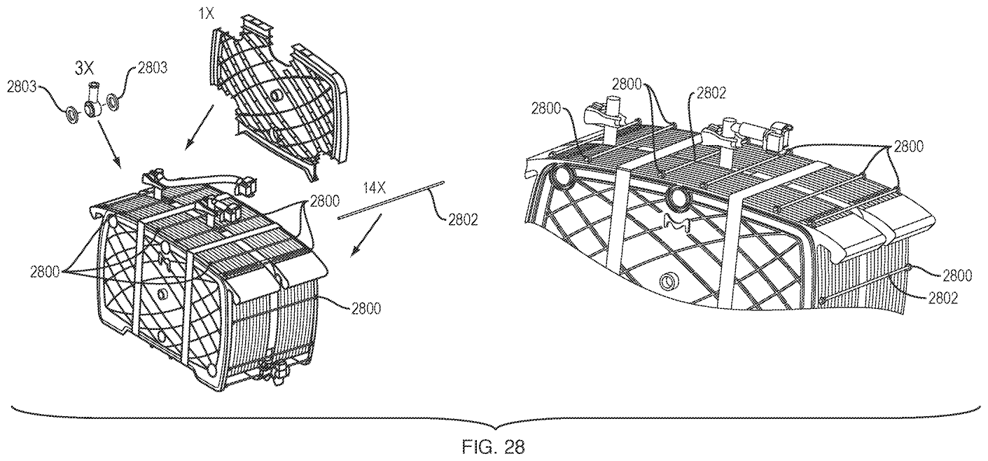

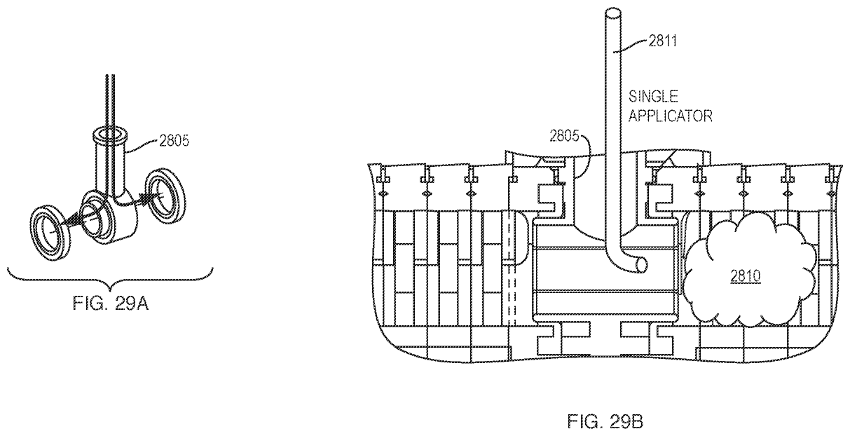

A connector plate 2250 is provided. The connector plate 2250 has three handles 2280, (only one handle is shown for ease of illustration, see FIG. 22B). Each connector plate 2250 can accommodate six sterile plugs 2260, which are to be loaded into the recesses in the connector plate(s) 2250. The pods 102, 500, 820 and connector plates 2250 are aligned and a male coupling, for e.g., a coupling device 2256, 2258 and a sleeve component are introduced into each recess within a connector plate 2250. Optional lock tabs/sleeve covers may then be removed (FIGS. 23A, 23B). The male couplings are further brought into the recesses until each sterile plug is fully engaged in the hollow spaces within the handle (FIGS. 24A, 24B). Each handle has two hollow spaces to receive the sterile plugs. An example of the handle is described in FIG. 4 of U.S. Pat. No. 7,137,974 B2 and also as shown in the lower left of FIG. 24B. Once the sterile plugs occupy the hollow spaces, each handle is depressed to move the sterile plugs away from the sterile fluid path as shown in FIGS. 25A, 25B. Male couplings in the pods and female couplings in the connector plates are then engaged to establish a sterile fluid path, as depicted in FIGS. 26A, 26B. At this point, the pods and connector plates are in contact with each other. In FIG. 22B, blind end connectors and male connectors, such as LYNX® S2S style connectors, are placed at the ends of the connector plates, respectively. In some embodiments, both sides have male connectors to establish flow path with an external sterile system, such as a tubing manifold as described above.

In FIG. 23A, the coupling devices 2256, 2258 are attached to the connector 2250 by mating the first ends the coupling devices 2256, 2258 to the first and second openings 2290 (FIG. 22) of the connector 2250 respectively. This may be a friction or interference fit. Alternatively, there may be a more secure fitting between the components to ensure that they stay together and remain sterile. The use of mating threads, snap connections, movable pawls and the like may also be used to make such a secure connection. As shown in FIG. 27, the coupling device uses a plurality of nubs 2291 which lock into corresponding grooves 2292 to make this connection. Optionally, the connector 2250 and coupling devices 2256, 2258 are locked together in a manner that prevents them from becoming inadvertently undone. In some embodiments, the locking of the components together is irreversible to ensure single usage.

In FIGS. 24A, 24B, each stem 2266 (as also shown below in FIG. 27) is moved toward the connector 2250 so as to move sterile plug(s) 2260 of each coupling device 2256, 2258 into a first opening 2274 of a port 2272. In FIGS. 25A, 25B, the port 2272 (see FIG. 27) is moved to its second position, creating a fluid pathway and fluid communication between the two coupling devices 2256, 2258. In FIGS. 26A, 26B, the stems 2266 are moved into a fully open position, sealing against each other.

FIG. 27 depicts a fluid transfer device 2200 comprising a connector 2250, for making connections between pods, according to some embodiments of the disclosure. The connector 2250 has a first and second opening 2252 and 2254 respectively and two coupling devices 2256 and 2258. These coupling devices each contain a sterile plug 2260 in the first opening 2262 of the coupling body 2264, a stem 2266 within that body 2264 and extending outwardly of the second opening 2268 of the body 2264. Each stem 2260 that extends out from the second opening of the body 2264 has a second opening 2270 that is connected to another component, which may be sterilized already. FIG. 27 depicts a representative type of sterile-to-sterile connector technology as described in U.S. Pat. No. 7,137,974, the disclosure of which is incorporated herein by reference.

The port 2272 is in the form of a slide that fits within the body of the connector 2250. The port 2272 has the ability of being in one of at least two positions, closed and open. It also contains a first opening 2274 and a second opening 2276. To ensure sterility, a perimeter seal 2278 is placed around opening 2276. The port 2272 as shown also has an actuating device 2280, that, in some embodiments, in the form of a handle(s). The handle 2280 in this embodiment also contains a latch 2282 that is used to lock the port 2272 in its open position when so actuated. As shown, the actuating device 2280 is a push handle although in some embodiments, the actuating device is a pull handle.

The first opening 2274 of the port 2272 in this embodiment is formed of two recesses 2284, 2286, one each facing the respective first and second openings of the connector 2250 with a wall 2288 between the two recesses 2284, 2286. Optionally, some embodiments of the connector 2250 in this embodiment comprise sterile barrier plugs.

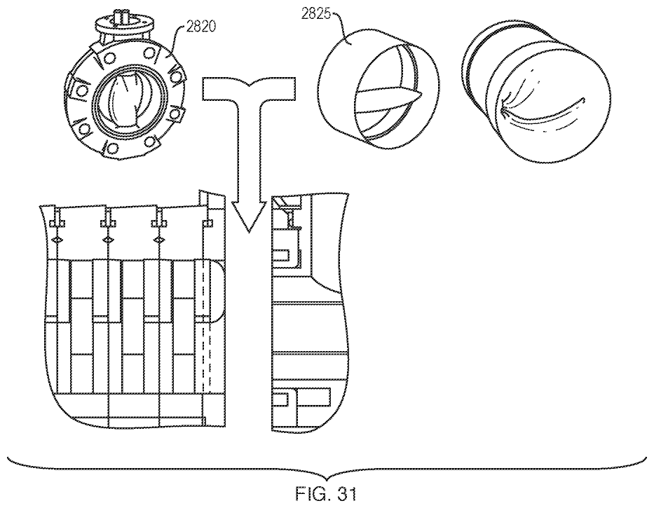

In some embodiments, closed pods that enable dripless disassembly may be provided. For example, FIG. 28 illustrates a pod with modified endcaps to have one or more holes or eyelets 2800 (four shown on the top of each endcap; one shown on the side of each endcap) configured and positioned to receive respective tie rods 2802. The gaskets 2803 sealing each of the ports must be symmetrically compressed to avoid accidental breach of closed device.

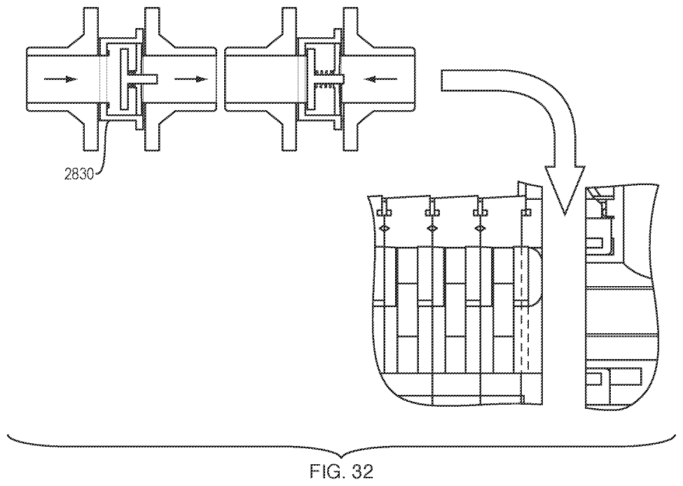

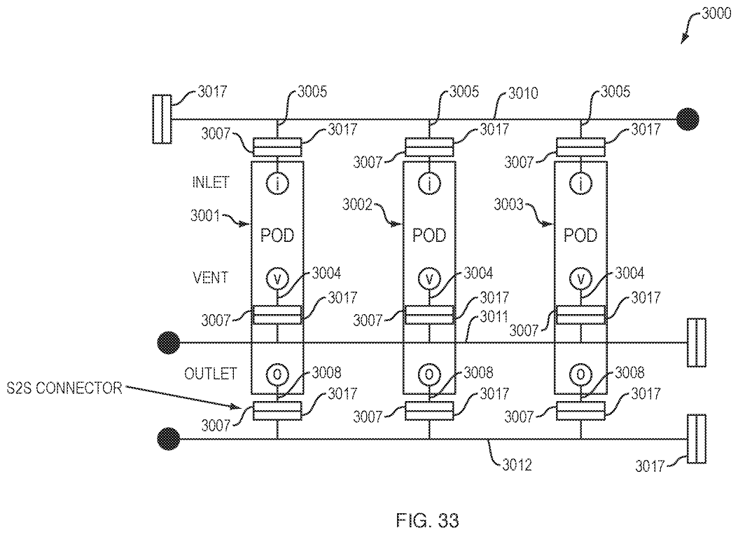

As shown in FIGS. 29A and 29B, deployable plugs or seals 2810, such as expanding cotton or foam (e.g., expanding insulation foam), may be inserted into a T-port 2805 of the pod with one or more applicators 2811 (two shown in FIG. 30). Geometric features (not shown) may be molded into or otherwise introduced into the T-ports 2805 to assist with the applicator(s) placement and alignment. Accordingly, in certain embodiments, a filtration system comprises two or more depth filtration devices, the depth filtration devices each comprising an inlet port, a vent port, a filtration media region or zone, and an outlet port; a mid-plate between each pair of depth filtration devices to provide adequate spacing for radial seal components such as TC tees and gaskets; a fluid inlet line and a sterile to sterile (S2S) connector connectable or connected to an inlet radial seal TC tee adjoining two depth filtration devices; a fluid vent line and a sterile-to-sterile (S2S) connector connectable or connected to a vent radial seal TC tee adjoining two depth filtration devices; a fluid outlet line and a sterile-to-sterile (S2S) connector connectable or connected to an outlet radial seal TC tee adjoining two depth filtration devices; and one or more tie rods 2802 and/or strapping to hold the depth filtration devices together and maintain integrity of the environmental seals between the devices. After the filtration operation is completed and prior to system disassembly, the fluid inlet/vent/outlet lines may be removed from their corresponding radial seal TC tees, for example, and expanding cotton, rayon, foams/sponges (e.g., polyurethane, polyether, polyester, and/or cellulose), or other absorbent plugging/sealing material 2810 may be deployed via compressed air, aerosol, propellant, and/or mechanical actuation into each radial seal TC tee to plug/seal the depth filtration ports using one or more applicators 2811 such as that shown in FIGS. 29B and 30. The volume of plugging/sealing material 2810 may range from 1 to 5 cubic inches (approximately 16.4-81.9 cm³). The applicator 2811 may be molded or constructed from thermoplastic materials such as polyethylene, polypropylene, polyamide, and/or polycarbonate. A double applicator 2811 could be used to deploy plugging/sealing material 2810 into both depth filtration devices simultaneously (FIG. 30). Radial seal TC tees may include features to aid in applicator placement and/or alignment. After the plugs/seals 2810 are successfully deployed to render the individual devices fully plugged/sealed, the radial seal TC tees can be removed and system disassembly can proceed in a dripless fashion.

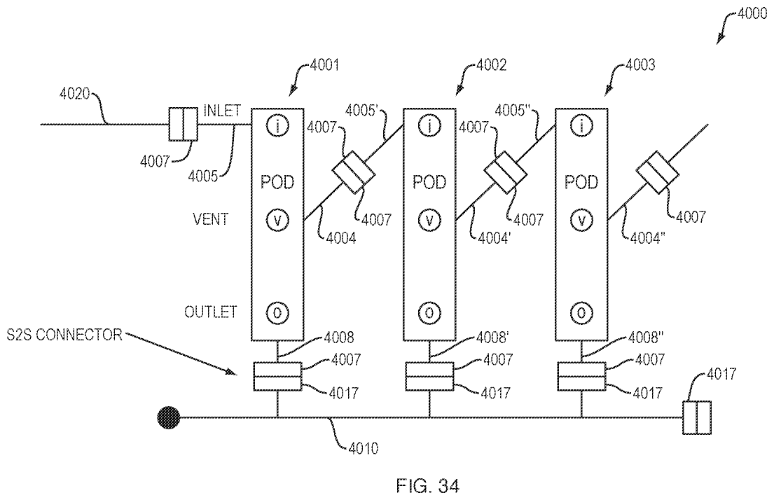

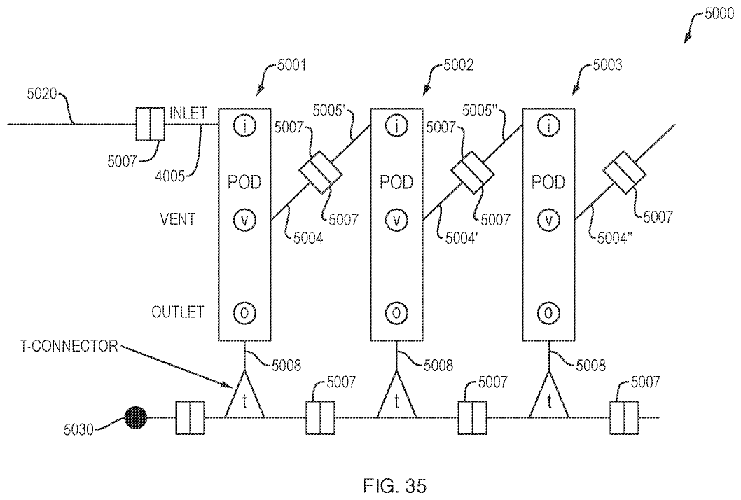

Dripless disassembly of closed pods also may be provided by using integrated valving, as exemplified in FIGS. 31 and 32. Accordingly, in certain embodiments, a filtration system comprises two or more depth filtration devices, the depth filtration devices each comprising an inlet port with integrated valving, a vent port with integrated valving, a filtration media region or zone, and an outlet port with integrated valving; a mid-plate between each pair of depth filtration devices to provide adequate spacing for radial seal components such as TC tees and gaskets; a fluid inlet line and a sterile-to-sterile (S2S) connector is connectable or connected to an inlet radial seal TC tee adjoining two depth filtration devices; a fluid vent line and a sterile-to-sterile (S2S) connector is connectable or connected to a vent radial seal TC tee adjoining two depth filtration devices; a fluid outlet line and a sterile-to-sterile (S2S) connector is connectable or connected to an outlet radial seal TC tee adjoining two depth filtration devices; and one or more tie rods and/or strapping to hold two depth filtration devices together and maintain integrity of the environmental seals between devices. The inlet/vent/outlet ports may incorporate integrated valving, such as a butterfly valve 2820, backdraft/damper valve 2825, and/or check valve 2830 as shown in FIGS. 31 and 32. The backdraft/damper and check valves may be automatically operated and close at the end of the filtration operation due to the absence of fluid pressure and/or flow, thereby sealing the device ports. The butterfly valve may be manually operated via external actuation (e.g. via a lever, switch, or dial) to seal the device ports after the filtration operation is completed and prior to system disassembly. After all valves are successfully closed to render the individual devices fully sealed, the radial seal TC tees can be removed and system disassembly can proceed in a dripless fashion.

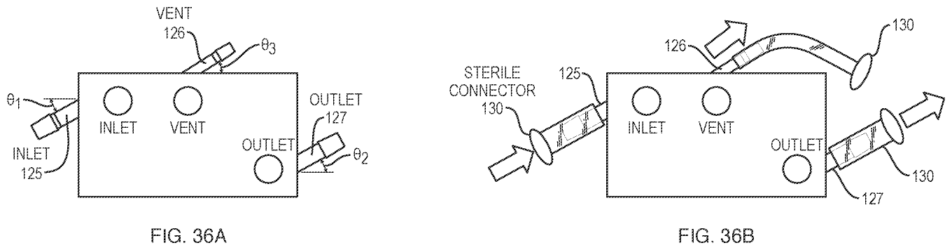

The number of sterile-to-sterile connectors can be substantially reduced. For comparison, FIG. 33 illustrates a closed three pod system where 24 sterile-to-sterile connectors are required. Shown is a filtration system 3000 comprising three depth filtration devices 3001, 3002, 3003 and three tubing manifolds 3010. 3011, 3012, the filtration devices each comprising an inlet port (i), a vent port (v), a filtration media zone, and an outlet port (o). The inlet port (i) is fluidly connected to the vent port (v). A fluid inlet line 3005 and a sterile-to-sterile (S2S) connector 3007 is connectable or connected to the inlet port 3005 of each of the three depth filtration devices. A fluid vent line 3004 and a sterile-to-sterile (S2S) connector 3007 is connectable or connected to the vent port (v) of each of the three depth filtration devices. A fluid outlet line 3008 and a sterile-to-sterile (S2S) connector 3007 is connectable or connected to the outlet port (o) of each of the three depth filtration devices. The tubing manifolds 3010, 3011, 3012 comprise tubing and four sterile-to-sterile connectors 3017. A first tubing manifold 3010 is connectable or connected to feedstream process tubing by an S2S connector 3017. The fluid inlet line 3005 of the first depth filtration device 3001 is connectable or connected to the first tubing manifold 3010 by an S2S connector; the fluid inlet line of the second depth filtration device 3002 is connectable or connected to the first tubing manifold 3010 by an S2S connector; the fluid inlet line 3005 of the third depth filtration device 3003 is connectable or connected to the first tubing manifold 3010 by an S2S connector; the fluid vent line 3004 of the first depth filtration device 3001 is connectable or connected to the second tubing manifold 3011 by an S2S connector; the fluid vent line 3004 of the second depth filtration 3002 device is connectable or connected to the second tubing manifold 3011 by an S2S connector; the fluid vent line 3004 of the third depth filtration device 3003 is connectable or connected to the second tubing manifold 3011 by an S2S connector; the second tubing manifold 3011 is connectable or connected to an air vent device (e.g., a Millipak+® barrier filter), not shown, by an S2S connector; the fluid outlet line 3008 of the first depth filtration device 3001 is connectable or connected to the third tubing manifold 3012 by an S2S connector; the fluid outlet line 3008 of the second depth filtration device 3002 is connectable or connected to the third tubing manifold by an S2S connector; the fluid outlet line of the third depth filtration device 3003 is connectable or connected to the third tubing manifold 3012 by an S2S connector; and the third tubing manifold 3012 is connectable or connected to a feedstream collection bag (not shown) by an S2S connector. This illustrated closed filtration system requires 24 sterile-to-sterile connectors.

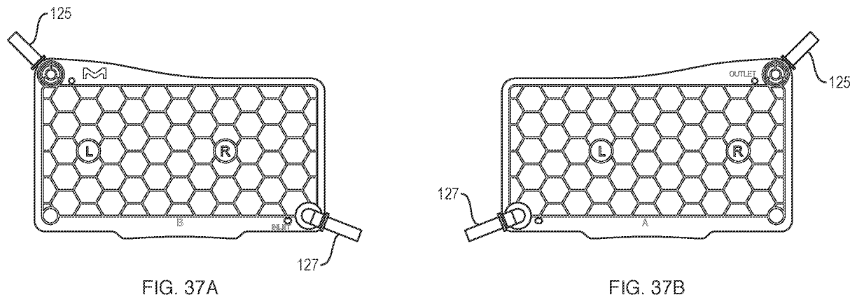

FIG. 34 illustrates an embodiment where the number of sterile-to-sterile (S2S) connectors can be reduced, saving costs. A three pod manifold is exemplified, but those skilled in the art will appreciate that different numbers of pods could be used. In the embodiment shown, there is a filtration system 4000 comprising three depth filtration devices 4001, 4002, 4003 and one tubing manifold 4010. The filtration devices each comprises an inlet port (i), a vent port (v), a filtration media zone, and an outlet port (o), the inlet port (i) being in fluidly communication with the vent port (v). There is a fluid inlet line 4005, 4005′, 4005″ and a sterile-to-sterile (S2S) connector connectable or connected to the inlet port (i) of each of the three depth filtration devices. A fluid vent line 4004, 4004′, 4004″ and a sterile-to-sterile (S2S) connector 4007 is connected to the vent port (v) of each of the three depth filtration devices. A fluid outlet line 4008, 4008′, 4008″ and a sterile-to-sterile (S2S) connector 4007 is connected to the outlet port (o) of each of the three depth filtration devices 4001, 4002, 4003. The tubing manifold 4010 comprises tubing and four sterile to sterile connectors 4017. The fluid inlet line 4005 of the first depth filtration device 4001 is connectable or connected to feed stream process tubing 4020 by means of an S2S connector 4007. Feedstream process tubing 4020 is connected to the first depth filtration device 4001 through fluid inlet line 4005 by means of a sterile-to-sterile connector 4007. The fluid inlet line 4005′ of the second depth filtration device 4002 is attached to the fluid vent line 4004 of the first depth filtration device 4001 by means of an S2S connector 4007; the fluid inlet line 4005″ of the third depth filtration device 4003 is attached to the fluid vent line 4004′of the second depth filtration device 4002 by means of an S2S connector 4007; the fluid vent line 4004″ of the third depth filtration device 4003 is attachable or attached to an air vent device (e.g., a Millipak+® barrier filter) (not shown) by a S2S connector 4007; the fluid outlet line 4008 of the first depth filtration device 4001 is attached to outlet tubing manifold 4010 by a S2S connector; the fluid outlet line 4008′ of the second depth filtration device 4002 is attached to outlet tubing manifold 4010 by a S2S connector; and the fluid outlet line 4008″ of the third depth filtration device 4003 is attached to outlet tubing manifold 4010 by an S2S connector. The outlet tubing manifold 4010 is attachable or attached to a feedstream collection bag (not shown) by a S2S connector 4017. The closed filtration system exemplified requires 16 sterile-to-sterile connectors.

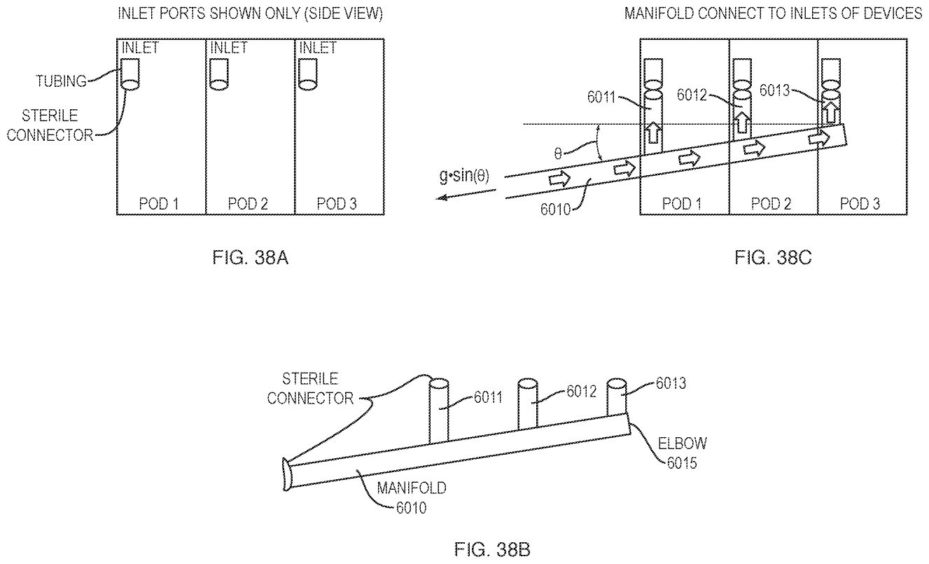

FIG. 35 illustrates another embodiment where the number of sterile-to-sterile (S2S) connectors can be reduced, saving costs. A three pod manifold is exemplified, but those skilled in the art will appreciate that different numbers of pods could be used. In the embodiment shown, there is shown a filtration system 5000 comprising three depth filtration devices 5001, 5002, 5003, each comprising an inlet port (i), a vent port (v), a filtration media zone, and an outlet port (o). The inlet port (i) is fluidly connected to the vent port (v); a fluid inlet line 5005, 5005′, 5005″ and a sterile-to-sterile (S2S) connector is connectable or connected to the inlet port of each of the three depth filtration devices; a fluid vent line 5004, 5004′, 5004″ and a sterile-to-sterile (S2S) connector 5007 is connected to the vent port of each of the three depth filtration devices; a fluid outlet line 5008, a T-connector (t) having a first connection point and a second connection point is attachable or attached to the outlet line 5008 of each of the three depth filtration devices, and two sterile-to-sterile (S2S) connectors 5007 are connectable or connected to the T-connectors (t) at the outlet ports of each of the three depth filtration devices. The fluid inlet line 5005 of the first depth filtration device 5001 is connected or connectable to feed stream process tubing 5002 by an S2S connector 5007. Feed stream process tubing 5020 is connected to the first depth filtration device 5001 through fluid inlet line 5005 by means of sterile-to-sterile connector 5007. The fluid inlet line 5005′ of the second depth filtration device 5002 is attached to the fluid vent line 5004 of the first depth filtration device 5001 by an S2S connector 5007. The fluid inlet line 5005″ of the third depth filtration device 5003 is attached to the fluid vent line 5004′ of the second depth filtration device 5002 by an S2S connector 5007; and the fluid vent line 5004″of the third depth filtration device 5003 is connectable or connected to an air vent device (e.g., a Millipak+® barrier filter) (not shown) by an S2S connector 5007. The first connection point of the T-connector (t) of the first depth filtration device 5001 is attached to a dead-ended plug 5030. The second connection point of the T-connector (t) of the first depth filtration device 5001 is attached to the first connection point of the T-connector (t) of the second depth filtration device 5002 by an S2S connector 5007, The second connection point of the T-connector (t) of the second depth filtration device 5002 is attached to the first connection point of the T-connector (t) of the third depth filtration device 5003 by an S2S connector; and the second connection point of the T-connector (t) of the third depth filtration device 5003 is attached to a feedstream collection bag (not shown) by an S2S connector. The closed filtration system exemplified requires 16 sterile to sterile connectors.

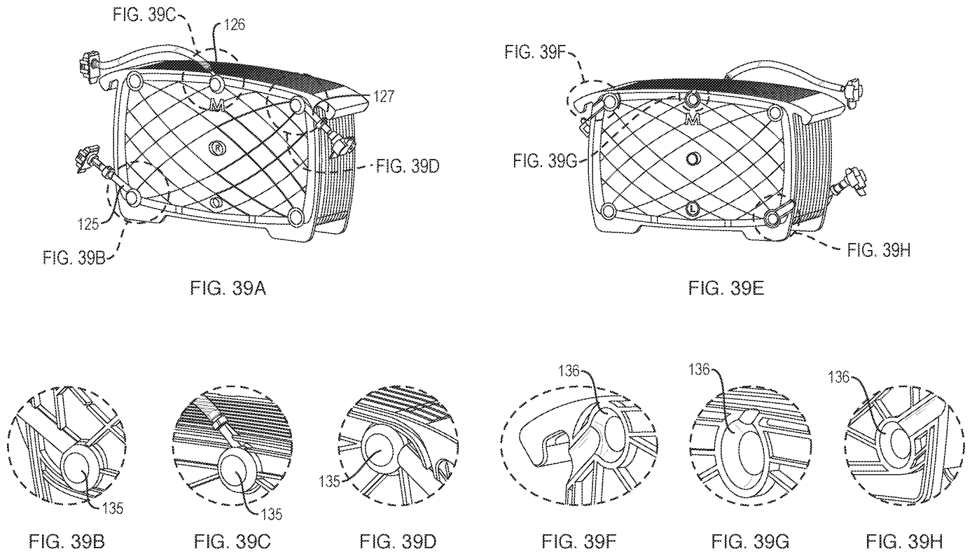

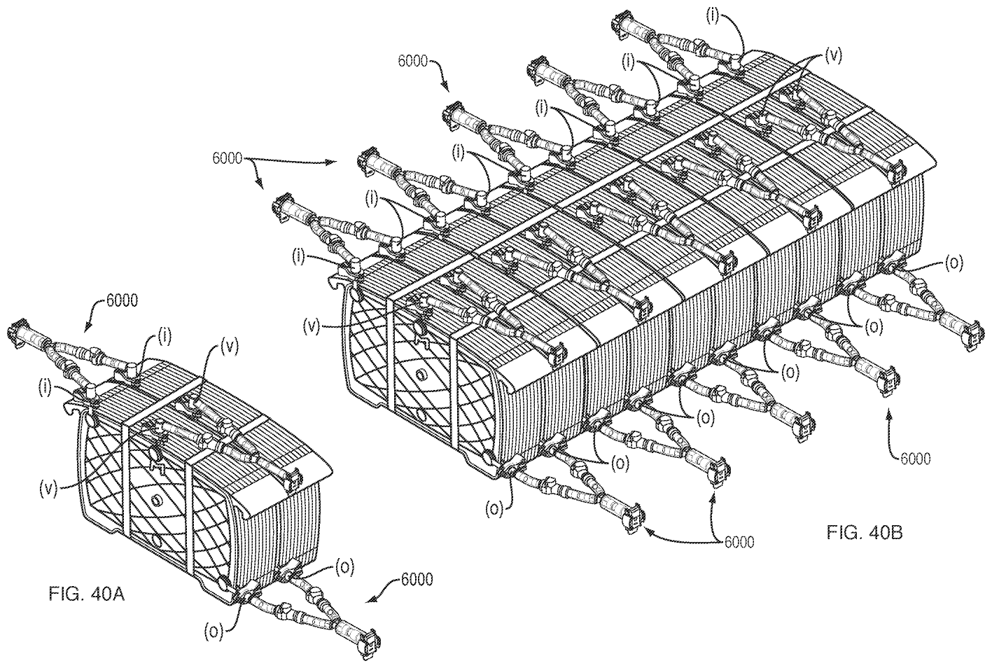

In some embodiments, closed processing devices can be achieved by using inclined barb fittings. For example, FIGS. 36A and 36B illustrate a depth filtration device with inlet, vent and outlet ports, and angled fittings 125, 126 and 127 fluidly connected to each respective port, and in FIG. 36B, to a respective sterile connector 130. FIGS. 37A and 37B illustrate a similar embodiment in membrane adsorber chromatography devices with no vent port necessary. Suitable angles for the angled fittings are between about 0 and about 90 degrees, preferably between about 20 and about 60 degrees.

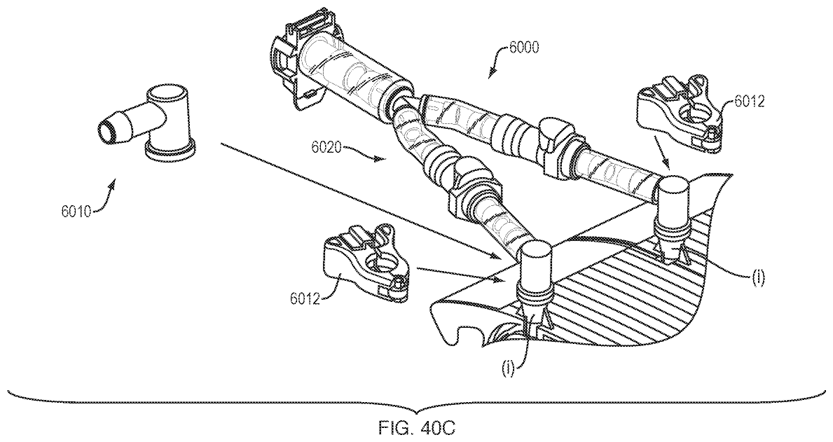

FIGS. 38A, 38B and 38C illustrate an embodiment where the inlet of each filtration device (Pod 1, Pod 2, Pod 3) is fluidly connected (i.e., connected to be in fluid communication) with a multi-branch manifold 6010 having branches 6011, 6012, 6013 of different lengths. In some embodiments, the branch lengths gradually decrease from 6011 to 6012 to 6013 towards a free end 6015 of the manifold as shown. The gradual decrease can be linear or non-linear.

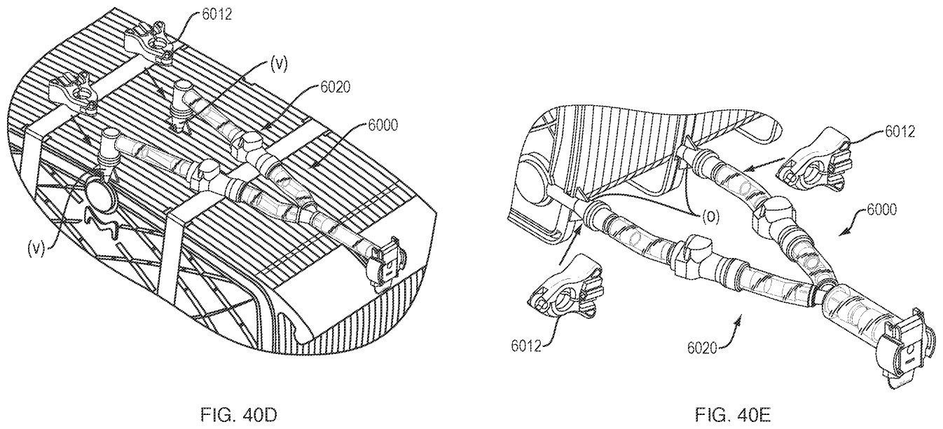

FIGS. 39A and 39B illustrate and embodiment that minimizes the thickness of multiple stacked pods. In the embodiment shown, on the right (R) side of the pod, there are three locations where hose barb fittings 125, 126, 127 are present. The right (R) side will be in contact with an opposing left (L) side of an adjacent pod when multiple filtration devices are stacked. On the right (R) side of the pod, each region 135 around a hose barb fitting is configured to be convex, and is receivable or received by a corresponding region 136 in the left (L) side that is configured to be concave (FIG. 38B). These convex and concave regions create a mating strategy reduces the thickness of the right (R) side cap thickness compared to assemblies where no such mating strategy is employed. Reduced end cap thickness results in a reduction of the thickness of the overall device, enabling more filter devices within a limited space in a holder hardware.

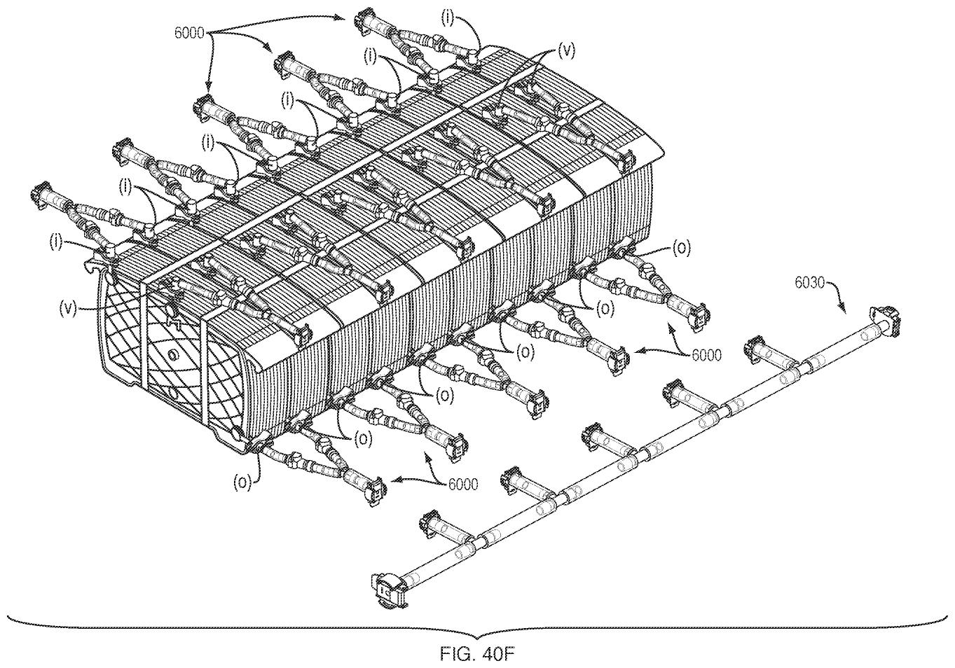

FIGS. 40A-E illustrate an embodiment that reduces the number of sterile connectors by half, thereby reducing the opportunity for sterility breaches. Accordingly, Y-connectors 6000 are used to fluidly connect respective inlets, outlet and/or vent ports of multiple filtration devices. For example, FIGS. 40A and 40B illustrates inlet ports (i), vent ports (v) and outlet ports (o) of adjacent filtration devices with 90° TC to barb connectors 6010 (FIG. 40C) attached to each port. Y-connectors 6000 may then be connected to the barb connectors 6010 to be in fluid communication with respective inlet ports (i), vent ports (v) and outlet ports (o) such as with a TC clamp 6012 such as a Q-clamp. A disconnector set 6020 (FIG. 40C, 40D, 40E) such as a SERIESLOCK™ disconnector may be connected to each branch of the Y-connector 6000 so that the filtration devices may be disconnected from the system (after straps holding the devices together, if present, are removed) in a dripless manner. FIGS. 40D and 40E show similar set ups for vent and outlet ports, respectively. FIG. 40F illustrates a plurality of Y-tube connectors 6000 fluidly connected to outlet ports connectable to an external manifold 6030 (only one shown). Similar manifolds can be connected or connectable to Y-tube connectors 6000 that are fluidly connected to the inlet and vent ports.

According to some embodiments, the bag, bioreactor, or single use container described herein is designed to receive and maintain a fluid, such as a biological fluid. In some embodiments, the bag, bioreactor, or single use container comprises monolayer walls or multilayer flexible walls formed of a polymeric composition such as polyethylene, including ultrahigh molecular weight polyethylene (UHMWPE), ultralow density polyethylene (ULDPE), linear low density polyethylene (LLDPE), low density polyethylene (LDPE), medium density polyethylene (MDPE); polypropylene (PP); ethylene vinyl alcohol (EVOH); polyvinyl chloride (PVC); polyvinyl acetate (PVA); ethylene vinyl acetate copolymers (EVA copolymers); thermoplastic elastomers (TPE), and/or blends or alloys of any of the foregoing materials as well as other various thermoplastics materials and additives as are known to those in the art. In some embodiments, the bag, bioreactor, or single use container comprises substrates, such as woven, nonwoven, and/or knitted substrates to provide additional strength. Such bags are available from, e.g., EMD Millipore Corporation, Burlington, Mass., USA.

The single use container may be formed by various processes including, but not limited to, co-extrusion of similar or different thermoplastics; multilayered laminates of different thermoplastics; welding and/or heat treatments, heat staking, calendaring, or the like. Any of the foregoing processes may further comprise layers of adhesives, tie layers, primers, surface treatments, and/or the like to promote adhesion between adjacent layers. By “different,” it is meant different polymer types such as polyethylene layers with one or more layers of EVOH as well as the same polymer type but of different characteristics such as molecular weight, linear or branched polymer, fillers and the like, are contemplated herein. Typically, medical grade plastics and, in some embodiments, animal-free plastics are used to manufacture the containers. Medical grade plastics may be sterilized, for e.g., by steam, ethylene oxide or radiation, including beta and/or gamma radiation or X-rays. Also, most medical grade plastics are specified for good tensile strength and low gas transfer. In some embodiments, the medical grade plastics comprise a polymeric material that is clear or translucent, allowing visual monitoring of the contents and, typically, are weldable and unsupported. In some embodiments, the container may be a bioreactor capable of supporting a biologically active environment, such as one capable of growing cells in the context of cell cultures. In some embodiments, the bag, bioreactor or container may be a two-dimensional (2D) or “pillow” bag or, alternatively, the container may be a three-dimensional (3D) bag. The particular geometry of the container or bioreactor is not limited in any embodiment disclosed herein. In some embodiments, the container may include a rigid base, which provides access points such as ports or vents. Any container described herein may comprise one or more inlets, one or more outlets and, optionally, other features such as sterile gas vents, spargers, and ports for the sensing of the liquid within the container for parameters such as conductivity, pH, temperature, dissolved gases, e.g., oxygen and carbon dioxide, and the like as known to those in the art. The container is of a sufficient size to contain fluid, such as cells and a culture medium, to be mixed from pilot scale, e.g., 50 L to small or to large production volume containers, e.g., 500 L to 3000 L or larger bioreactors.

In some embodiments, the bag, bioreactor, or container may be a single use, deformable, foldable bag that defines a closed volume, is sterilizable for single use, capable of accommodating contents, such as biopharmaceutical fluids, in a fluid state, and can accommodate a mixing device partially or completely within the closed volume of the container, e.g., working volume. In some embodiments, the closed volume can be opened, such as by suitable valving, to introduce a fluid into the volume, and to expel fluid therefrom, such as after mixing is complete.

In some embodiments, each container contains, either partially or completely within its interior, an impeller assembly for mixing, dispersing, homogenizing, and/or circulating one or more liquids, gases and/or solids contained in the container.

All ranges for formulations recited herein include ranges therebetween and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4, or 3.1 or more.

Reference throughout this specification to “one embodiment,” “certain embodiments,” “one or more embodiments,” “some embodiments,” or “an embodiment” indicates that a feature, structure, material, or characteristic described in connection with the embodiment is included in at least one embodiment of the disclosure. Therefore, the appearances of the phrases such as “in one or more embodiments,” “in certain embodiments,” “in one embodiment” “some embodiments,” or “in an embodiment” throughout this specification are not necessarily referring to the same embodiment.

Although some embodiments have been discussed above, other implementations and applications are also within the scope of the following claims. Although the specification describes, with reference to some embodiments, it is to be understood that these embodiments are merely illustrative of the principles and applications of the technologies described within this disclosure. It is therefore to be further understood that numerous modifications may be made to the illustrative embodiments and that other arrangements and patterns may be devised without departing from the spirit and scope of the embodiments according to the disclosure. Furthermore, particular features, structures, materials, or characteristics may be combined in any suitable manner in any one or more of the embodiments.

Publications of patents, patent applications and other non-patent references, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

1. An apparatus for treating a biological fluid, comprising:
a plurality of filtration devices; each of the plurality of filtration devices comprising filtration media, at least one inlet and at least one outlet; and
a first insert plate and a second insert plate opposite the first insert plate, wherein the plurality of filtration devices is disposed therebetween.

2. The apparatus of claim 1, wherein each of said plurality of filtration devices further comprises at least one vent port, and wherein the vent port optionally terminates at a vent filter.

3. The apparatus for treating a biological fluid of claim 1, wherein the at least one inlet further comprises a sterile-to-sterile connector, and/or the at least one outlet further comprises a sterile-to-sterile connector.

4. (canceled)

5. (canceled)

6. The apparatus for treating a biological fluid of claim 1, wherein the at least one inlet from each of the plurality of device is connected to be in fluid communication via a manifold, and/or the at least one outlet from each of the plurality of devices is connected to be in fluid communication via a manifold.

7. (canceled)

8. The apparatus for treating a biological fluid of claim 2, wherein the at least one vent port from each of the plurality of devices is connected to be in fluid communication via a manifold.

9. The apparatus of claim 6, wherein the manifold comprises a sterile-to-sterile connector.

10. The apparatus of claim 1, wherein the filtration media comprises media effective for virus filtration, depth filtration or adsorptive filtration, and optionally the filtration media comprises a chromatography membrane.

11. (canceled)

12. The apparatus of claim 1, wherein the plurality of filtration devices are combined and loaded onto a cart having holder hardware comprising a side A and a side B.

13. The apparatus of claim 12, wherein the holder hardware comprises a pressure gauge, a hydraulic pump, a clamp rod, a frame, and two platens.

14. An apparatus for sealing a sterilized filtration device, comprising:
a container comprising two hard bases and a plastic film, having a plurality of filtration devices disposed therebetween, wherein one of the hard bases has a protruded hose barb fitting connected to tubing and a sterile-to-sterile connector, the plastic film sealing the plurality of filtration devices between the hard bases.

15. The apparatus of claim 14, wherein the plastic film is thermally welded, bonded or otherwise joined to at least part of a perimeter of the hard bases.

16. The apparatus of claim 15, comprising two plastic films, wherein the plastic film overhangs the perimeter of the hard bases.

17. The apparatus of claim 14, further comprising at least one alignment key in at least one hard base.

18. The apparatus of claims 14, wherein each end plate has at least one groove for holding a strapping band.

19. The apparatus of claims 14, further comprising at least one hose barb adapter or at least one blind end cap, and wherein each hose barb adapter or blind end cap adaptor further comprises a gasket and a snap fit connection.

20. An assembly comprising a filtration module comprising filtration media and one or more fluid ports;
and an insert plate having a thickness and configured to attach to a face of said filtration module, said insert plate having at least one recess configured and positioned to receive a connecting component that is fluidly connectable to one of said fluid ports such that said connecting component is contained within the thickness of said insert plate when said insert plate is attached to said face of said filtration module.

21. An assembly comprising a filtration module comprising filtration media and one or more fluid ports; said filtration module having an end face, said end face having at least one recess configured and positioned to receive a connecting component that is fluidly connectable to one of said fluid ports such that said connecting component is contained within the recess.

22. The assembly of claim 21, wherein said filtration module is enclosed in a sterile barrier.

23. The assembly of claim 22, wherein said sterile barrier comprises a poly bag.

24. A method of deploying a seal into a filtration device comprising filtration media, an inlet and an outlet, the method comprising inserting an applicator into each of said inlet and outlet, and introducing through each said applicator a sealing material.

25. The method of claim 24, wherein said sealing material comprises a material selected from the group consisting of cotton, rayon, foam, polyurethane, polyether, polyester and cellulose.

26. An apparatus for treating a biological fluid, comprising:
a plurality of filtration devices; each of the plurality of filtration devices comprising filtration media, at least one inlet and at least one outlet; wherein inlets of two of the plurality of filtration devices are fluidly connected by a first Y-connector, and optionally wherein outlets of two of the plurality of filtration devices are fluidly connected by a second Y-connector.

27. (canceled)

28. The apparatus of claim 26, wherein each of the plurality of filtration devices further comprises a vent.

29. The apparatus of claim 28, wherein vents of two of the plurality of filtration devices are fluidly connected by a third Y-connector.

30. The apparatus of claim 26, wherein the first Y-connector is fluidly connectable to a manifold.

31. The assembly of claim 22, wherein said filtration module is enclosed in a sterile barrier.

32. The assembly of claim 31, wherein said sterile barrier comprises a poly bag.
